(19) United States
(12) Patent Application Publication
(10) Pub. No.: US 2024/0149730 A1
(43) Pub. Date: May 9, 2024

(54) METHOD AND APPARATUS FOR OPTIMAL TIMED CHARGING

(71) Applicant: Volvo Car Corporation, Goteborg (SE)

(72) Inventors: Andreas Ropel, Goteborg (SE); Ben Lloyd, Goteborg (SE); Mathias Le Saux, Goteborg (SE); Kostas Chatziioannou, Goteborg (SE); Klas Signell, Goteborg (SE)

(21) Appl. No.: 17/981,823

(22) Filed: Nov. 7, 2022

(51) Int. Cl. B60L 53/62; B60L 50/64; B60L 53/65; B60L 53/66; B60L 58/16

(52) U.S. Cl. CPC B60L 53/62; B60L 50/64; B60L 53/65; B60L 53/66; B60L 58/16

(57) ABSTRACT

Embodiments relate to a system. The system comprises a charging station. The charging station is configured to charge an electric vehicle. The charging station comprises a control unit. The control unit is configured to establish a connection between the charging station and a vehicle computer system; receive a message comprising a charging time from the vehicle computer system; extract state-of-health information of a battery pack through the vehicle computer system via the connection established; and determine a charging sequence and communicate a signal to a charger unit to optimally ramp-up charging to the battery pack. The state-of-health information comprises a first state-of-health information that corresponds to a first portion of the battery pack, a second state-of-health information that corresponds to a second portion of the battery pack, and a third state-of-health information that corresponds to a third portion of the battery pack.

### FIELD OF THE INVENTION

This invention relates to charging an electric vehicle. The invention is more particularly concerned with a system and method for optimal timed charging of an electric vehicle.

### BACKGROUND

An electric vehicle (EV) is a vehicle that uses one or more electric motors for propulsion. It can be powered by a collector system, with electricity from extravehicular sources, or it can be powered autonomously by a battery, or it can be powered autonomously by an electric charge storage. The electric vehicles (EV) that are powered by the battery or an electric charge storage are plug-in electric vehicles (PEV) that require charging from an external energy source of electricity. The external energy source may be a power grid, wireless source, or an electric charge storage.

Systems and methods exist for charging plug-in electric vehicles. Separate systems exist to charge the electric vehicle from the power grid, wireless source, or an electric charge storage. Current charging stations are systems used for charging the electric vehicles continuously for a period of time when the electric vehicles are plugged in. Also, there are drawbacks that the charging stations do not have capability to charge for allotted time and provide maximum charge during the allotted time. Further, there are no existing systems that enable easy interaction and communication with the charging station to determine as well as update charging time and battery parameters.

The problem is that when a user wants to charge for a short time and not until the battery is optimally charged (e.g., full or until a recommended threshold is reached), the user just plugs in the charger and unplugs it upon return. However, there needs to be a system that allows the user to provide an amount of desired time for charging and a system that maximizes charging during the allotted time (e.g., user provided length of time).

Therefore, there is a need for a system and method for optimal timed charging of an electric vehicle and for providing maximum charge during the allotted time without damaging the battery pack.

### SUMMARY

The following presents a summary to provide a basic understanding of one or more embodiments described herein. This summary is not intended to identify key or critical elements or delineate any scope of the different embodiments and/or any scope of the claims. The sole purpose of the summary is to present some concepts in a simplified form as a prelude to the more detailed description presented herein.

In one or more embodiments described herein, systems, devices, computer-implemented methods, methods, apparatus and/or computer program products are presented that facilitate optimal timed charging.

In an aspect, a system is described herein. The system comprises a charging station. The charging station is configured to charge an electric vehicle. The charging station comprises a control unit. The control unit is configured to establish a connection between the charging station and a vehicle computer system; receive a message comprising a charging time from the vehicle computer system; extract state-of-health information of a battery pack through the vehicle computer system via the connection established; and determine a charging sequence and communicate a signal to a charger unit to optimally ramp-up charging to the battery pack. The charging sequence comprises a combination of at least one of a level 1 charging, a level 2 charging, and a level 3 charging.

In another aspect, a system is described herein. The system comprises a charging station. The charging station is configured to charge an electric vehicle. The charging station comprises a control unit. The control unit is configured to establish a connection between the charging station and an external device; receive an update to at least one of a charging time and state-of-health information via the external device; and modify a charging sequence and communicate a signal to a charger unit to optimally ramp-up charging to the battery pack. The charging sequence comprises a combination of at least one of a level 1 charging, a level 2 charging, and a level 3 charging.

In yet another aspect, a method is described herein. The method comprises: establishing, by a charging station, a connection between the charging station and a vehicle computer system; receiving, by the charging station, a message comprising a charging time from the vehicle computer system; extracting, by the charging station, state-of-health information of a battery pack through the vehicle computer system via the connection established; and determining a charging sequence and communicating, by the charging station, a signal to a charger unit to optimally ramp-up charging to the battery pack. The charging sequence comprises a combination of at least one of a level 1 charging, a level 2 charging, and a level 3 charging.

In yet another aspect, a non-transitory storage medium is described herein. The non-transitory storage medium stores a sequence of instructions, which when executed by a processor cause: establishing a connection between the charging station and a vehicle computer system; receiving a message comprising a charging time from the vehicle computer system; extracting state-of-health information of a battery pack through the vehicle computer system via the connection established; and determining a charging sequence and communicating a signal to a charger unit to optimally ramp-up charging to the battery pack. The charging sequence comprises a combination of at least one of a level 1 charging, a level 2 charging, and a level 3 charging.

In yet another aspect, a method is described herein. The method comprises: establishing, by a charging station, a connection between the charging station and an external device; receiving, by the charging station, an update to at least one of a charging time and state-of-health information via the external device; and modifying a charging sequence and communicating, by the charging station, a signal to a charger unit to optimally ramp-up charging to the battery pack. The charging sequence comprises a combination of at least one of a level 1 charging, a level 2 charging, and a level 3 charging.

In yet another aspect, a non-transitory storage medium is described herein. The non-transitory storage medium stores a sequence of instructions, which when executed by a processor cause: establishing a connection between the charging station and an external device; receiving an update to at least one of a charging time and state-of-health information via the external device; and modifying a charging sequence and communicating a signal to a charger unit to optimally ramp-up charging to the battery pack. The charging sequence comprises a combination of at least one of a level 1 charging, a level 2 charging, and a level 3 charging.

In yet another aspect, a system is described. The system comprises a charging station. The charging station comprises a memory and a processor. The memory stores computer executable components. The processor executes the computer executable components stored in the memory. The computer executable components comprise a communication link establishment component, a receiving component, an information extraction component, and a charging sequence determination component. The communication link establishment component establishes a connection between the charging station and a vehicle computer system. The receiving component receives a first message comprising a charging time. The information extraction component extracts state-of-health information of a battery pack from the vehicle computer system. The charging sequence determination component determines a charging sequence and communicating a signal to a charger unit to optimally ramp-up charging to the battery pack.

The methods and systems disclosed herein may be implemented in any means for achieving various aspects and may be executed in a form of a non-transitory machine-readable medium embodying a set of instructions that, when executed by a machine, causes the machine to perform any of the operations disclosed herein. Other features will be apparent from the accompanying drawings and from the descriptions that follow.

### BRIEF DESCRIPTION OF THE FIGURES

These and other aspects of the present invention will now be described in more detail, with reference to the appended drawings showing exemplary embodiments of the present invention, in which:

FIG. 1 illustrates a system, according to one or more embodiments.

FIG. 2 illustrates a block diagram of the charging station, according to one or more embodiments.

FIG. 3 illustrates a method of optimal timed charging, according to one or more embodiments.

FIG. 4 illustrates a method of optimal timed charging involving an external device, according to one or more embodiments.

FIG. 5 illustrates a battery pack comprising an individual battery, according to one or more embodiments.

FIG. 6 illustrates a battery pack comprising a plurality of batteries, according to one or more embodiments.

FIG. 7 schematically shows a battery pack comprising a battery and a battery management system, according to one or more embodiments.

FIG. 8 illustrates a message received by a charging station, according to one or more embodiments.

FIG. 9 illustrates a message, with an update to the charging time, received by a charging station, according to one or more embodiments.

FIG. 10 shows a schematic diagram of a charging station, according to one or more embodiments.

FIG. 11 provides a depiction of data flow between a charging station, a vehicle computer system, and an external device, according to one or more embodiments.

FIG. 12A shows a structure of the neural network/machine learning model with a feedback loop, according to one or more embodiments.

FIG. 12B shows a structure of the neural network/machine learning model with reinforcement learning, according to one or more embodiments.

FIG. 13 illustrates a system, according to one or more embodiments.

FIG. 14 illustrates a system, according to one or more embodiments.

FIG. 15 illustrates a system, according to one or more embodiments.

FIG. 16 illustrates a system, according to one or more embodiments.

FIG. 17 illustrates a system performing an optimal timed charging, according to one or more embodiments.

Other features of the present embodiments will be apparent from the accompanying drawings and from the detailed description that follows.

### DETAILED DESCRIPTION

### Definitions and General Techniques

For simplicity and clarity of illustration, the figures illustrate the general manner of construction, and descriptions and details of well-known features and techniques may be omitted to avoid unnecessarily obscuring the present disclosure. The dimensions of some of the elements in the figures may be exaggerated relative to other elements to help improve understanding of embodiments of the present disclosure. The same reference numeral in different figures denotes the same element.

Although the following detailed description contains many specifics for the purpose of illustration, a person of ordinary skill in the art will appreciate that many variations and alterations to the following details can be made and are considered to be included herein. Accordingly, the following embodiments are set forth without any loss of generality to, and without imposing limitations upon, any claims set forth. It is also to be understood that the terminology used herein is for the purpose of describing particular embodiments only and is not intended to be limiting. Unless defined otherwise, all technical and scientific terms used herein have the same meaning as commonly understood by one with ordinary skill in the art to which this disclosure belongs.

The articles “a” and “an” are used herein to refer to one or to more than one (i.e., to at least one) of the grammatical object of the article. By way of example, “an element” means one element or more than one element. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

The terms “first,” “second,” “third,” and the like in the description and in the claims, if any, are used for distinguishing between similar elements and not necessarily for describing a particular sequence or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements but may include other elements not expressly listed or inherent to such process, method, system, article, device, or apparatus.

No element, act, or instruction used herein should be construed as critical or essential unless explicitly described as such. Furthermore, as used herein, the term “set” is intended to include items (e.g., related items, unrelated items, a combination of related items, and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

It should be understood that the terms “system,” “device,” “unit,” and/or “module” are used in this disclosure to refer to a different component, component, portion, or component of the different levels of the order. However, if other expressions may achieve the same purpose, these terms may be replaced by other expressions.

The terms “couple,” “coupled,” “couples,” “coupling,” and the like should be broadly understood and referred to as connecting two or more elements mechanically, electrically, and/or otherwise. Two or more electrical elements may be electrically coupled together, but not be mechanically or otherwise coupled together. Coupling may be for any length of time, e.g., permanent, or semi-permanent or only for an instant. “Electrical coupling” includes electrical coupling of all types. The absence of the word “removably,” “removable,” and the like near the word “coupled,” and the like does not mean that the coupling, etc. in question is or is not removable.

The term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

As defined herein, two or more elements or modules are “integral” or “integrated” if they operate functionally together. As defined herein, two or more elements are “non-integral” if each element can operate functionally independently.

The present invention may be embodied in other specific forms without departing from its spirit or characteristics. The described embodiments are to be considered in all respects only as illustrative and not restrictive. The scope of the invention is, therefore, indicated by the appended claims rather than by the description herein. All variations which come within the meaning and range of equivalency of the claims are to be embraced within their scope.

As defined herein, “approximately” can mean within a specified or unspecified range of the specified or unspecified stated value. In some embodiments, “approximately” can mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As used herein, the term component is intended to be broadly construed as hardware, firmware, and/or a combination of hardware and software.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products i.e., one or more modules of computer program instructions encoded on a computer-readable medium for execution by, or to control the operation of, data processing apparatus. The computer-readable medium may be a machine-readable storage device, a machine-readable storage substrate, a memory device, a composition of matter affecting a machine-readable propagated signal, or a combination of one or more of them. The term “computing system” encompasses all apparatus, devices, and machines for processing data, including by way of example, a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal (e.g., a machine-generated electrical, optical, or electromagnetic signal) that is generated to encode information for transmission to a suitable receiver apparatus.

The actual specialized control hardware or software code used to implement these systems and/or methods is not limiting of the implementations. Thus, the operation and behavior of the systems and/or methods described herein without reference to specific software code, it being understood that any software and any hardware can be designed to implement the systems and/or methods based on the description herein.

A computer program (also known as a program, software, software application, script, or code) may be written in any appropriate form of programming language, including compiled or interpreted languages, and it may be deployed in any appropriate form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, for example, without limitation, a Field Programmable Gate Array (FPGA), an Application Specific Integrated Circuit (ASIC), Application Specific Standard Products (ASSPs), System-On-a-Chip (SOC) systems, Complex Programmable Logic Devices (CPLDs), etc.

Processors suitable for the execution of a computer program include, by way of example, both general and special purpose microprocessors, and any one or more processors of any appropriate kind of digital computer. Generally, a processor will receive instructions and data from a read-only memory or a random-access memory or both. Elements of a computer can include a processor for performing instructions and one or more memory devices for storing instructions and data. Generally, a computer will also include, or be operatively coupled to receive data, transfer data or both, to/from one or more mass storage devices for storing data e.g., magnetic disks, magneto optical disks, optical disks, or solid-state disks. However, a computer need not have such devices. Moreover, a computer may be embedded in another device, e.g., a mobile telephone, a personal digital assistant (PDA), a mobile audio player, a Global Positioning System (GPS) receiver, etc. Computer-readable media suitable for storing computer program instructions and data include all forms of non-volatile memory, media and memory devices, including, by way of example, semiconductor memory devices (e.g., Erasable Programmable Read-Only Memory (EPROM), Electronically Erasable Programmable Read-Only Memory (EEPROM), and flash memory devices), magnetic disks (e.g., internal hard disks or removable disks), magneto optical disks (e.g. Compact Disc Read-Only Memory (CD ROM) disks, Digital Versatile Disk-Read-Only Memory (DVD-ROM) disks) and solid-state disks. The processor and the memory may be supplemented by, or incorporated in, special purpose logic circuitry.

To provide for interaction with a user, implementations may be realized on a computer having a display device, e.g., a Cathode Ray Tube (CRT) or Liquid Crystal Display (LCD) monitor, for displaying information to the user, and a keyboard and a pointing device, e.g., a mouse or a trackball, by which the user may provide input to the computer. Other kinds of devices may be used to provide for interaction with a user as well; for example, feedback provided to the user may be any appropriate form of sensory feedback, e.g., visual feedback, auditory feedback, or tactile feedback; and input from the user may be received in any appropriate form, including acoustic, speech, or tactile input.

Implementations may be realized in a computing system that includes a back-end component, e.g., a data server, or that includes a middleware component, e.g., an application server, or that includes a front-end component, e.g., a client computer having a graphical user interface or a Web browser through which a user may interact with an implementation, or any appropriate combination of one or more such back-end, middleware, or front-end components. The components of the system may be interconnected by any appropriate form or medium of digital data communication, e.g., a communication network. Examples of communication networks include a Local Area Network (LAN) and a Wide Area Network (WAN), e.g., Intranet and Internet.

The computing system may include clients and servers. A client and server are generally remote from each other and typically interact through a communication network. The relationship of the client and server arises by virtue of computer programs running on the respective computers and having a client-server relationship to each other.

Embodiments of the present invention may comprise or utilize a special purpose or general purpose computer including computer hardware. Embodiments within the scope of the present invention may also include physical and other computer-readable media for carrying or storing computer-executable instructions and/or data structures. Such computer-readable media can be any media that can be accessed by a general purpose or special purpose computer system. Computer-readable media that store computer-executable instructions are physical storage media. Computer-readable media that carry computer-executable instructions are transmission media. Thus, by way of example and not limitation, embodiments of the invention can comprise at least two distinctly different kinds of computer-readable media: physical computer-readable storage media and transmission computer-readable media.

Although the present embodiments have been described with reference to specific example embodiments, it will be evident that various modifications and changes may be made to these embodiments without departing from the broader spirit and scope of the various embodiments. For example, the various devices, units, and modules described herein may be enabled and operated using hardware circuitry (e.g., Complementary Metal Oxide Semiconductor (CMOS) based logic circuitry), firmware, software (e.g., embodied in a non-transitory machine-readable medium), or any combination of hardware, firmware, and software. For example, the various electrical structures and methods may be embodied using transistors, logic gates, and electrical circuits (e.g., Application Specific Integrated Circuit (ASIC) and/or Digital Signal Processor (DSP) circuit).

In addition, it will be appreciated that the various operations, processes, and methods disclosed herein may be embodied in a non-transitory machine-readable medium and/or a system. Accordingly, the specification and drawings are to be regarded in an illustrative rather than a restrictive sense.

Physical computer-readable storage media includes RAM, ROM, EEPROM, CD-ROM or other optical disk storage (such as CDs, DVDs, etc.), magnetic disk storage or other magnetic storage devices, solid-state disks or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links which can be used to carry desired program code means in the form of computer-executable instructions or data structures, and which can be accessed by a general purpose or special purpose computer. Combinations of the above, that enable the transport of electronic data between computer systems and/or modules and/or other electronic devices, are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (NIC), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer-executable instructions may be, for example, binary, intermediate format instructions such as assembly language, or even source code. Although the subject matter has been described in language specific to structural features and/or methodological acts, it is to be understood that the subject matter defined in the claims is not necessarily limited to the described features or acts described. Rather, the described features and acts are disclosed as example forms of implementing the claims.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order to achieve desired results, this should not be understood as requiring that such operations be performed in the particular order shown or in sequential order or that all illustrated operations be performed, to achieve desirable results. In certain circumstances, multitasking and parallel processing may be advantageous. Moreover, the separation of various system components in the implementations should not be understood as requiring such separation in all implementations, and it should be understood that the described program components and systems may generally be integrated together in a single software product or packaged into multiple software products.

Even though particular combinations of features are recited in the claims and/or disclosed in the specification, these combinations are not intended to limit the disclosure of possible implementations. Other implementations are within the scope of the following claims. For example, the actions recited in the claims may be performed in a different order and still achieve desirable results. In fact, many of these features may be combined in ways not specifically recited in the claims and/or disclosed in the specification. Although each dependent claim may directly depend on only one claim, the disclosure of possible implementations includes each dependent claim in combination with every other claim in the claim set.

Further, the methods may be practiced by a computer system including one or more processors and computer-readable media such as computer memory. In particular, the computer memory may store computer-executable instructions that when executed by one or more processors cause various functions to be performed such as the acts recited in the embodiments.

The disclosure provides illustration and description but is not intended to be exhaustive or to limit the implementations to the precise form disclosed. Modifications and variations are possible in light of the disclosure herein or may be acquired from practice of the implementations.

Those skilled in the art will appreciate that the invention may be practiced in network computing environments with many types of computer system configurations including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, etc. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Unless otherwise defined herein, scientific, and technical terms used in connection with the present invention shall have the meanings that are commonly understood by those with ordinary skill in the art. Further, unless otherwise required by context, singular terms shall include pluralities and plural terms shall include the singular. Generally, nomenclatures used in connection with the invention described herein are those well-known and commonly used in the art.

The methods and techniques of the present invention are generally performed according to conventional methods well known in the art and as described in various general and more specific references that are cited and discussed throughout the present specification unless otherwise indicated. The nomenclatures used in connection with, and the procedures and techniques of embodiments herein, and other related fields described herein are those well-known and commonly used in the art.

The following terms and phrases, unless otherwise indicated, shall be understood to have the following meanings.

The term “vehicle” as used herein refers to a thing used for transporting people or goods. Automobiles, cars, trucks, buses etc., are examples of vehicles.

The term “electric vehicle (EV)” as used herein refers to an automobile, as defined in 49 CFR 523.3, intended for highway use, powered by an electric motor that draws current from an on-vehicle energy storage device, such as a battery, which is rechargeable from an off-vehicle source, such as residential or public electric service or an on-vehicle fuel powered generator. The EV may be two or more wheeled vehicles manufactured for use primarily on public streets, roads.

The EV may be referred to as an electric car, an electric automobile, an electric road vehicle (ERV), a plug-in vehicle (PV), a plug-in vehicle (xEV), etc., and the xEV may be classified into a plug-in all-electric vehicle (BEV), a battery electric vehicle, a plug-in electric vehicle (PEV), a hybrid electric vehicle (HEV), a hybrid plug-in electric vehicle (HPEV), a plug-in hybrid electric vehicle (PHEV), etc.

The term “plug-in electric vehicle (PEV)” as used herein refers to an Electric Vehicle that recharges the on-vehicle primary battery by connecting to the power grid.

The term “plug-in vehicle (PV)” as used herein refers to an electric vehicle rechargeable through wireless charging from an electric vehicle supply equipment (EVSE) without using a physical plug or a physical socket.

The term “heavy duty vehicle (HD Vehicle)” as used herein refers to any four- or more wheeled vehicle as defined in 49 CFR 523.6 or 49 CFR 37.3 (bus).

The term “light duty plug-in electric vehicle” as used herein refers to a three or four-wheeled vehicle propelled by an electric motor drawing current from a rechargeable storage battery or other energy devices for use primarily on public streets, roads and highways and rated at less than 4, 545 kg gross vehicle weight.

The term “level 1 charging” refers to a charge that uses 120-207 Volts. Every electric vehicle or plug-in hybrid can be charged on level 1 charging by plugging the charging equipment into a regular wall outlet. Level 1 charging may be the slowest way to charge an EV. Level 1 charging, generally, adds between 3 and 5 miles of range per hour.

The term “level 2 charging” refers to a charge that uses 208-240 Volts. Level 2 charging is the most commonly used for daily EV charging. Level 2 charging equipment can be installed at home, at the workplace, as well as in public locations like shopping plazas, train stations and other destinations. Level 2 charging can replenish between 12 and 80 miles of range per hour, depending on the power output of the Level 2 charger, and the vehicle's maximum charge rate.

The term “level 3 charging” refers to a charge that uses 400-900 Volts DC. Level 3 charging is the fastest type of charging available and can recharge the EV at a rate of 3 to 20 miles of range per minute. Unlike Level 1 charging and Level 2 charging that uses alternating current (AC), Level 3 charging uses direct current (DC).

The term “user” as used herein includes driver and/or passenger of a vehicle.

The term “bidirectional communication” as used herein refers to an exchange of data between two components. In an example, the first component can be a vehicle and the second component can be an infrastructure that is enabled by a system of hardware, software, and firmware. This communication is typically wireless. In another example, the first component can be a charging system and the second component can be a charging station.

As used herein “Machine learning” refers to algorithms that give a computer the ability to learn without being explicitly programmed including algorithms that learn from and make predictions about data. Machine learning algorithms include, but are not limited to, decision tree learning, artificial neural networks (ANN) (also referred to herein as a “neural net”), deep learning neural network, support vector machines, rule-based machine learning, random forest, etc. For the purposes of clarity, algorithms such as linear regression or logistic regression can be used as part of a machine learning process. However, it is understood that using linear regression or another algorithm as part of a machine learning process is distinct from performing a statistical analysis such as regression with a spreadsheet program. The machine learning process can continually learn and adjust the classifier as new data becomes available and does not rely on explicit or rules-based programming. The ANN may be featured with a feedback loop to adjust the system output dynamically as it learns from the new data as it becomes available. In machine learning, backpropagation and feedback loops are used to train the AI/ML model improving the model's accuracy and performance over time. Statistical modeling relies on finding relationships between variables (e.g., mathematical equations) to predict an outcome.

As used herein, the term “Data set” (or “Dataset”) is a collection of data. In the case of tabular data, a data set corresponds to one or more database tables, where every column of a table represents a particular variable, and each row corresponds to a given record of the data set in question. The data set lists values for each of the variables, such as height and weight of an object, for each member of the data set. Each value is known as a datum.

The term “autonomous mode” as used herein refers to an operating mode which is independent and unsupervised.

The term “autonomous communication” as used herein comprises communication over a period with minimal supervision under different scenarios and is not solely or completely based on pre-coded scenarios or pre-coded rules or a predefined protocol. Autonomous communication, in general, happens in an independent and an unsupervised manner.

The term “autonomous vehicle” also referred to as self-driving vehicle, driverless vehicle, robotic vehicle as used herein refers to a vehicle incorporating vehicular automation, that is, a ground vehicle that can sense its environment and move safely with little or no human input. Self-driving vehicles combine a variety of sensors to perceive their surroundings, such as thermographic cameras, Radio Detection and Ranging (radar), Light Detection and Ranging (lidar), Sound Navigation and Ranging (sonar), Global Positioning System (GPS), odometry and inertial measurement unit. Control systems, designed for the purpose, interpret sensor information to identify appropriate navigation paths, as well as obstacles and relevant signage.

The term “energy source” as used herein refers to the electrical and mechanical equipment and their interconnections necessary to generate or convert power.

The term “AC” as used herein refers to alternating current.

The term “DC” as used herein refers to direct current.

The term “wired connection” as used herein refers to a connection using physical cables to connect between the devices.

The term “wireless connection” as used herein refers to electrical connection between two or more points that do not use an electrical conductor as a medium.

The term “power grid” as used herein refers to a network, usually of a power company, for transmitting and distributing electric power.

The term “wireless source” as used herein refers to a wireless electrical energy source to transfer electrical power without wires and is based on technologies using time-varying electric, magnetic, or electromagnetic fields.

The term “circuit” as used herein refers to an arrangement of interconnected components that has at least one input and one output terminal, and whose purpose is to produce at the output terminals a signal that is a function of the signal at the input terminals.

The term “processor” as used herein refers to a device that interprets and executes instructions, consisting of at least an instruction control unit and an arithmetic unit that contains a central processing unit.

The term “component” as used herein refers to a part or element of a larger whole, especially a part of a machine, a circuit, or a vehicle.

The term “battery management system (BMS)” used herein refers to a system that is used to monitor and control power storage systems, assure health of battery cells, and deliver power to vehicle systems. Isolation products have numerous uses inside BMS in the electrical domains of Electric Vehicles (EV) or Hybrid Electric Vehicles (HEV).

The term “degraded cells” as used herein refers to energy storage cells where the physical and chemical changes have occurred. The degraded cells can store or deliver energy less than the actual capacity.

The term “healthy cells” as used herein refers to energy storage cells which can store or deliver energy equal to the actual capacity.

The term “moderate degraded cells” as used herein refers to energy storage cells which can store or deliver energy less than the actual capacity but equal to a threshold capacity.

The term “control unit” or “control module” or “electronic control unit” refers to a functional unit in a computer system that controls one or more units of the peripheral equipment. For example, it may be a component of a charging system that provides instructions or signals to the charger unit to charge the battery pack as per the charging requirement.

As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

The term “battery pack” as used herein refers to a set of any number of identical batteries or individual cells of a battery. The “battery pack” may also refer to a set of non-identical batteries. The batteries in the battery pack may be configured in a series, parallel or a mixture of both to deliver the desired voltage, capacity, and/or power density.

The term “charging station” as used herein refers to a device that includes at least one docking terminal with a charger for charging a battery pack. The term “charging station,” as used further refers to an apparatus that can function as a source of power for charging the battery pack of an electric vehicle including facilitating data communications between the electric vehicle and the charging station. The communications may be established through a wired connection or a wireless connection. The charging station is also capable of charging the electric vehicle either through a wired connection or a wireless connection.

The term “charging system” as used herein refers to an apparatus that is capable of charging a battery pack. The charging system is capable of monitoring and controlling the battery pack. The charging system is also capable of calculating and monitoring battery parameters (e.g., battery impedance, battery resistance, battery temperature, state-of-charge, state-of-health, etc.). The charging system is communicatively coupled to a vehicle computer system. The charging system is also communicatively coupled to the charging station.

The term “vehicle computer system” refers to an embedded system in automotive electronics that controls one or more of the electrical systems or subsystems in a vehicle. The computer executes a large number of different software functions in the powertrain, chassis, driver assistance, and infotainment domains, etc. that are executed on separate control units. The vehicle computer system may be communicatively coupled with an external device of a user. The vehicle computer system may also be communicatively coupled with the charging station.

The term “electronic control unit” (ECU), also known as an “electronic control module” (ECM), is a system that controls one or more subsystems. An ECU may be installed in a car or other motor vehicle. It may refer to many ECUs, and can include but not limited to, Engine Control Module (ECM), Powertrain Control Module (PCM), Transmission Control Module (TCM), Brake Control Module (BCM) or Electronic Brake Control Module (EBCM), Central Control Module (CCM), Central Timing Module (CTM), General Electronic Module (GEM), Body Control Module (BCM), and Suspension Control Module (SCM). ECUs together are sometimes referred to collectively as the vehicles' computer or vehicles' central computer and may include separate computers. In an example, the electronic control unit can be embedded system in automotive electronics. In another example, the electronic control unit is wirelessly coupled with the automotive electronics.

The term “infotainment system” or “in-vehicle infotainment system” (IVI) as used herein refers to a combination of systems which are used to deliver entertainment and information. In an example, the information may be delivered to the driver and the passengers of a vehicle through audio/video interfaces, control elements like touch screen displays, button panel, voice commands, and more. Some of the main components of an in-vehicle infotainment systems are integrated head-unit, heads-up display, high-end Digital Signal Processors (DSPs), and Graphics Processing Units (GPUs) to support multiple displays, operating systems, Controller Area Network (CAN), Low-Voltage Differential Signaling (LVDS), and other network protocol support (as per the requirement), connectivity modules, automotive sensors integration, digital instrument cluster, etc.

As used herein, a “sensor” is a device that measures physical input from its environment and converts it into data that can be interpreted by either a human or a machine. Most sensors are electronic (the data is converted into electronic data), but some are simpler, such as a glass thermometer, which presents visual data.

The term “charging sequence” as used refers to a charging pattern defined by the charging system or the charging station based on the battery parameters (e.g., state-of-health) and charging time. The charging sequence may comprise a charging level for a predefined charging time segment. The charging sequence may also comprise a charging level for a predefined portion (e.g., healthy cells, degraded cells) of the battery pack. The charging level may comprise a regular charging, a fast charging, and a trickle charging.

The term “maximum charging” or “optimally charging” as used refers to a maximum rate at which the charging is provided to the battery pack during the charging time without damaging the battery pack.

The term “charging time” as used herein refers to a time allotted for charging. The charging time may be provided by the user. The charging time may also be determined by the charging station or the charging system. The charging time may be split into charging time segments. Each charging time segment may correspond to a different charging level. Each charging time segment may correspond to charging the different portion of the battery pack.

The term “state-of-health (SoH)” refers to a figure of merit of the condition of a battery pack, compared to its ideal conditions. The state-of-health (SoH) of a battery pack describes the difference between a battery pack being studied and a fresh battery pack and considers cell aging. The SoH is defined as the ratio of the maximum battery charge to its rated capacity. The SoH is represented in percentage form.

The term “state-of-charge (SoC)” refers to the level of charge of an electric battery relative to its capacity. The units of SoC are percentage points (0%=empty; 100%=full). An alternative form of the same measure is the depth of discharge (DoD), the inverse of SoC (100%=empty; 0%=full). SoC is normally used when discussing the current state of a battery in use, while DoD is most often seen when discussing the lifetime of the battery after repeated use.

The term “trickle charging” refers to charging a battery pack continuously or periodically with a very small current. The trickle charge also refers to a continuous, slow charge applied to the battery pack.

The term “fast charging” refers to charging a battery pack faster than regular charging.

The term “regular charging” refers to charging a battery pack by supplying a standard charging voltage employed according to the capacity of the battery pack.

The term “communication” as used herein refers to the transmission of information and/or data from one point to another. Communication may be by means of electromagnetic waves. It is also a flow of information from one point, known as the source, to another, the receiver. Communication comprises one of the following: transmitting data, instructions, and information or a combination of data, instructions, and information. Communication happens between any two communication systems or communicating units. The term “in communication with” may refer to any coupling, connection, or interaction using electrical signals to exchange information or data, using any system, hardware, software, protocol, or format, regardless of whether the exchange occurs wirelessly or over a wired connection. The term communication includes systems that combine other more specific types of communication, such as V2I (Vehicle-to-Infrastructure), V2I (Vehicle-to-Infrastructure), V2N (Vehicle-to-Network), V2V (Vehicle-to-Vehicle), V2P (Vehicle-to-Pedestrian), V2D (Vehicle-to-Device) and V2G (Vehicle-to-Grid) and Vehicle-to-Everything (V2X) communication. V2X communication is the transmission of information from a vehicle to any entity that may affect the vehicle, and vice versa. The main motivations for developing V2X are occupant safety, road safety, traffic efficiency and energy efficiency. Depending on the underlying technology employed, there are two types of V2X communication technologies: cellular networks and other technologies that support direct device-to-device communication (such as Dedicated Short-Range Communication (DSRC), Port Community System (PCS), Bluetooth®, Wi-Fi®, etc.). Further, the emergency communication apparatus is configured on a computer with the communication function and is connected for bidirectional communication with the on-vehicle emergency report apparatus by a communication line through a radio station and a communication network such as a public telephone network or by satellite communication through a communication satellite. The emergency communication apparatus is adapted to communicate, through the communication network, with communication terminals including a road management office, a police station, a fire department, and a hospital. The emergency communication apparatus can be also connected online with the communication terminals of the persons concerned, associated with the occupant (the driver receiving the service) of the emergency-reporting vehicle.

The term “message structure” as used herein refers to a structure of a communication message when a query and fetch operation happens. It comprises payload and header where payload is the quantitative value of the information that is shared, and header refers to what information is being shared. The message structure acts as a superstructure to accommodate any sub protocol structure such as AMQP, MQTT, Zigbee, etc.

The term “vehicle gateway system” as used herein refers to a device that connects two systems that use different protocols. It is a system which takes care of any outbound or inbound communications between any two vehicle ecosystem units.

For device communication, currently there are problem specific protocols like Unified Diagnostic Services (UDS), Open Diagnostic eXchange format (ODX), Diagnostics Over Internet Protocol (DoIP), On-Board Diagnostics (OBD), etc., in addition to general purpose messaging protocols like MQTT, AMQP, STOMP, ZigBee, etc. Invention described herein addresses some concerns with the existing technologies and how to enable next generation vehicle to everything (V2X) semantic communication in a more context aware and dynamic manner. This would help the vehicle to be autonomous not just in functioning but in communication with other vehicles, humans, grids, central clouds, and infrastructures. This enables next generation Vehicle to everything (V2X) semantic communication in a more context aware and dynamic manner. V2X communication technology includes but not limited to Vehicle-to-Infrastructure (V2I), Vehicle-to-Network (V2N), Vehicle-to-Vehicle (V2V), Vehicle-to-Grid (V2G), Vehicle-to-Device (V2D) and Vehicle-to-Pedestrian (V2P), etc.

As referred herein, “vehicle-to-device communication” or “V2D” communication is a particular type of vehicular communication system that consists of exchange of information between a vehicle and any electronic device that may be connected to the vehicle itself. Allows vehicles to exchange information with any smart device, usually via Bluetooth® protocol.

As referred herein, “vehicle to grid” or “V2G,” also known as Vehicle-to-home (V2H) or Vehicle-to-load (V2L) describes a system in which plug-in electric vehicles (PEV) sell demand response services to the grid communication. It is a member of the V2X group of technologies that provides bidirectional data exchange between plug-in hybrid vehicles (PHEV), battery electric vehicles (BEV), and even hydrogen fuel cell vehicles (HFCEV) with the smart grid in support of electrification of transport. This communication facilitates balance loads more efficiently as well as reduce utility bill costs.

The term “artificial intelligence unit” refers to any system that perceives its environment and takes actions that maximize its chance of achieving its goals. Artificial intelligence unit utilizes a plurality of machine learning algorithms that allow systems to automatically improve through experience.

As used herein “trickle charging” refers to charging a battery pack continuously or periodically with a very small current. The trickle charge also refers to a continuous, slow charge applied to the battery pack.

As used herein “fast charging” is charging a battery pack faster than regular charging.

As used herein “regular charging” refers to charging a battery pack by supplying a standard charging voltage employed according to the capacity of the battery pack.

The term “communication system” or “communication module” as used herein refers to a system which enables the information exchange between two points. The process of transmission and reception of information is called communication. The major elements of communication include but are not limited to a transmitter of information, channel or medium of communication and a receiver of information.

As used herein “artificial intelligence (AI)” refers to the intelligence demonstrated by machines, as opposed to the natural intelligence displayed by humans. AI research has been defined as any system that perceives its environment and takes actions that maximize its chance of achieving its goals. The term “artificial intelligence” is now described in terms of rationality and acting rationally, which does not limit how intelligence can be articulated.

The term “connection” as used herein refers to a communication link. It refers to a communication channel that connects two or more devices for the purpose of data transmission. It may refer to a physical transmission medium such as a wire, or to a logical connection over a multiplexed medium such as a radio channel in telecommunications and computer networking. A channel is used for information transfer of, for example a digital bit stream, from one or several senders to one or several receivers. A channel has a certain capacity for transmitting information, often measured by its bandwidth in Hertz (Hz) or its data rate in bits per second. For example, a Vehicle-to-Vehicle (V2V) communication may wirelessly exchange information about the speed, location and heading of surrounding vehicles.

The term “vehicle to vehicle (V2V) communication” refers to the technology that allows vehicles to broadcast and receive messages. The messages may be omni-directional messages, creating a 360-degree “awareness” of other vehicles in proximity. Vehicles may be equipped with appropriate software (or safety applications) that can use the messages from surrounding vehicles to determine potential crash threats as they develop.

The term “protocol” as used herein refers to a procedure required to initiate and maintain communication; a formal set of conventions governing the format and relative timing of message exchange between two communications terminals; a set of conventions that govern the interaction of processes, devices, and other components within a system; a set of signaling rules used to convey information or commands between boards connected to the bus; a set of signaling rules used to convey information between agents; a set of semantic and syntactic rules that determine the behavior of entities that interact; a set of rules and formats (semantic and syntactic) that determines the communication behavior of simulation applications; a set of conventions or rules that govern the interactions of processes or applications within a computer system or network; a formal set of conventions governing the format and relative timing of message exchange in a computer system; a set of semantic and syntactic rules that determine the behavior of functional units in achieving meaningful communication; a set of semantic and syntactic rules for exchanging information.

Technical Problem: The problem is that when a user wants to charge for a short time and not until the battery is optimally charged (e.g., full or until a recommended threshold is reached), the user just plugs in the charger and unplugs it when they return. However, there needs to be a system that allows the user to provide an amount of desired time for charging and a system that maximizes charging during the allotted time (e.g., user provided length of time).

Technical Solution: In an aspect, a charging station is configured to receive one or more messages regarding the amount of time the battery needs to be charged. For example, a user using the infotainment system can provide 10 minutes as charging time (e.g., the user may desire to charge only for 10 minutes). In addition to receiving the amount of time to charge, the charging station will also have the ability to extract or receive the state of the health of the battery or the battery cells. Using the additional information, a charging station can optimally ramp up charging and prevent damage to the battery or its cells while providing maximum charge during the allotted time. In an aspect, the charging station can establish a bidirectional communication that allows the vehicle computer system to communicate any updates to the state of the health or provide updates to the timing of the charge. For example, if the user decides to increase the amount of time to charge, the user may communicate that information through external devices such as an iPhone, requiring the charging time to be increased via the connected vehicle. In another aspect, once the user has made the connection to the charging station, the user can use an external device to communicate with the charging station to update the time to charge.

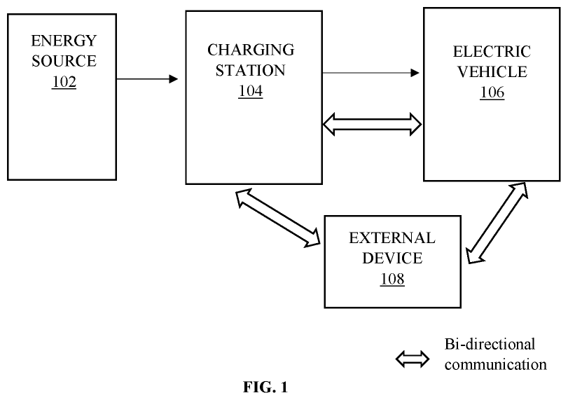

In an aspect, a system is described herein. As an example, FIG. 1 illustrates the system, according to one or more embodiments. The system comprises an energy source 102, a charging station 104, an electric vehicle 106 and an external device 108. The energy source 102 supplies power to the charging station 104. The energy source 102 may be a solar power station. The energy source 102 may also be a power storage unit which gets power from an external source. The energy source 102 may also be a power grid. The charging station 104 is configured to charge the electric vehicle 106. Note that the control unit is a component of the charging station that provides instructions or a signal to the charger unit to charge the battery pack of the electric vehicle 106. The signal is used to convey information or instructions, typically by prearrangement between the parties concerned. The signal may also be an electrical impulse or radio wave. In an embodiment, the control unit communicates a signal to the charger unit to limit the rate at which electric current is added to or drawn from electric batteries to prevent damage. The control unit is also configured to provide maximum charging to the battery pack during the allotted time.

The electric vehicle 106 described herein may operate in an autonomous mode or a self-driving mode. The electric vehicle 106 comprises a charging system, a battery pack, and a vehicle computer system. In an embodiment, the battery pack comprises an individual battery comprising a plurality of cells. In another embodiment, the battery pack comprises at least one of a first battery (e.g., primary battery), a second battery (e.g., secondary battery), and a third battery (e.g., tertiary battery). The battery pack may comprise identical batteries. The battery pack may comprise non-identical batteries. In an embodiment, each battery of the battery pack may comprise equal capacity to store and deliver power. In another embodiment, each battery of the battery pack may comprise different capacity to store and deliver power. Each battery of the battery pack may comprise the plurality of cells. Each battery of the battery pack may be electrically connected with one another to get charged. The charging station 104 charges each battery of the battery pack. In an embodiment, the charging station 104 charges each battery of the battery pack in a random manner (e.g., round robin manner). In another embodiment, the charging station 104 charges each battery of the battery pack in a sequential order (e.g., in a series connection). In yet another embodiment, the charging station 104 charges each battery of the battery pack parallelly at the same time.

The vehicle computer system comprises an infotainment system and/or an automotive head unit. The vehicle computer system comprises an electronic control unit (ECU). The vehicle computer system may also comprise a vehicle gateway system. The vehicle gate way system refers to a device that connects two systems that use different protocols. It is a system which takes care of any outbound or inbound communications between any two vehicle ecosystem units. The vehicle computer system comprises a user interface (e.g., graphical user interface) that enables a user to interact with the system. In an embodiment, icons on a graphical user interface (GUI) or display of the infotainment system of a computer system are re-arranged based on a priority score of the content of the message. The message may comprise a message structure. The processor tracks the messages that need to be displayed at a given time and generates a priority score, wherein the priority score is determined based on the action that needs to be taken by the user, the time available before the user input is needed, content of the message to be displayed, criticality of the user's input/action that needs to be taken, the sequence of the message or messages that need to be displayed and executed, and the safety of the overall scenario. For example, in case of a determining a charging sequence, the messages in queue for displaying could be a charging sequence, a charging time segment, a charging level type, a modified charging sequence, amount of power, establishment of communication link, etc. In all these messages that need a user's attention, a priority score is provided based on the actions that need to be taken by the user, the time available for the user to receive the displayed message and react with an action, the content of the message, criticality of the user's input/action, sequence of the messages that need to be executed, and safety of the overall scenario. Considering the above example, the message that intimates the user that a charging sequence determined may be of higher priority as compared to intimating establishment of communication link. Therefore, the charging sequence takes priority and takes such a place on the display (example, center of the display) which can grab the users' attention immediately. The priority of the messages are evaluated dynamically as the situation is evolving and thus the display icons, positions, and sizes of the text or icon on the display are changed in real time and dynamically. In an embodiment, more than one message is displayed and highlighted as per the situation and the user's actions. Further, while charging, if the charging time is updated for example, a modified charging sequence is determined, the message dynamically changes and intimates the user about the modified charging sequence.

In an embodiment, the vehicle computer system enables the user to interact with the system through a voice input. In another embodiment, the vehicle computer system enables the user to interact with and control the system through a text input. The vehicle computer system, comprising the infotainment system, is a component providing a unified hardware interface for the system, including touch screens, display screens, buttons and system controls for numerous integrated information and entertainment functions. The vehicle computer system is configured to initiate and establish communication with the charging station 104. In an embodiment, the charging station 104 is also configured to initiate and establish communication with the vehicle computer system.

The connection is established between the charging station 104 and the electric vehicle 106 upon connecting (e.g., via wired connection, wireless connection) the electric vehicle 106 to the charging station 104. The connection established may provide a bidirectional communication. The charging station 104 and the electric vehicle 106 can transmit as well as receive signals and/or data in both directions. In another embodiment, communication established between the charging station 104 and the electric vehicle 106 is through wired communication. In yet another embodiment, communication established between the charging station 104 and the electric vehicle 106 is through wireless communication technology (e.g., Wireless Fidelity (Wi-Fi®), Bluetooth®, Cellular technology, Zigbee® etc.).

The external device 108 may be a smart phone, a laptop, a computer, a personal digital assistant, a desktop computer, a tablet, and a personal digital assistant. The external device 108 may be an electronic device associated with the user. The external device 108 interacts with the components of the system. In an embodiment, the external device 108 is configured to initiate and establish communication with the charging station 104. In an embodiment, the charging station 104 is configured to initiate and establish communication with the external device 108.

In an embodiment, the connection is established between the charging station 104 and the external device 108. The connection established may be a wireless connection. The connection established may provide bidirectional communication. The charging station 104 and the external device 108 can transmit as well as receive signals and/or data in both directions. In another embodiment, the communication established between the charging station 104 and the external device 108 is through wired communication. In yet another embodiment, the communication established between the charging station 104 and the external device 108 is through wireless communication technology (e.g., Wireless Fidelity (Wi-Fi®), Bluetooth®, Cellular technology, Zigbee® etc.).

In another embodiment, the connection is established between the vehicle computer system of the electric vehicle 106 and the external device 108. The connection established may be a wireless connection or a wired connection. The connection established may provide bidirectional communication. The electric vehicle 106 and the external device 108 can transmit as well as receive signals and/or data in both directions. In another embodiment, the communication established between the electric vehicle 106 and the external device 108 is through wired communication. In yet another embodiment, the communication established between the electric vehicle 106 and the external device 108 is through wireless communication (e.g., Wireless Fidelity (Wi-Fi®), Bluetooth®, Cellular technology, Zigbee® etc.).

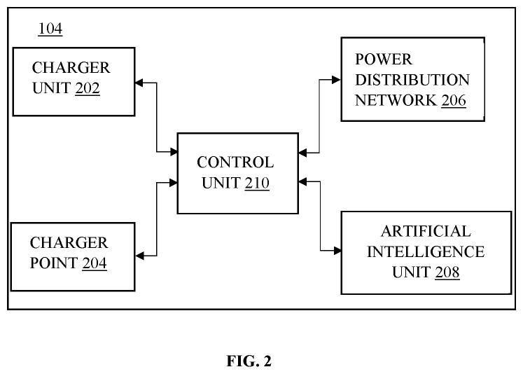

The system comprises the charging station 104. As an example, FIG. 2 illustrates a block diagram of the charging station 104, according to one or more embodiments. The charging station 104 is configured to charge an electric vehicle 106. The charging station 104 comprises a control unit 210. The control unit 210 is configured to establish a connection between the charging station 104 and a vehicle computer system; receive a message comprising a charging time from the vehicle computer system; extract state-of-health information of a battery pack through the vehicle computer system via the connection established; and determine a charging sequence and communicate a signal to a charger unit 202 to optimally ramp-up charging to the battery pack. The state-of-health information comprises a first state-of-health information that corresponds to a first portion of the battery pack, a second state-of-health information that corresponds to a second portion of the battery pack, and a third state-of-health information that corresponds to a third portion of the battery pack. The charging sequence comprises a combination of at least one of a level 1 charging, a level 2 charging, and a level 3 charging. In yet another embodiment, the connection established between the charging station 104 and the vehicle computer system comprises a wired connection. In yet another embodiment, the connection established between the charging station 104 and the vehicle computer system comprises a wireless connection. In yet another embodiment, the connection is configured to establish two-way communication between the charging station 104 and a vehicle computer system.

In an embodiment, the charging station 104 further comprises: the charger unit 202; a charger point 204; a power distribution network 206; and an artificial intelligence unit 208. In another embodiment, the charger unit 202 is configured to receive energy from an energy source upon receiving the signal from the control unit 210 to receive energy from the energy source; and converts the energy based on charging requirements of the electric vehicle in accordance with the signal received from the control unit 210. In yet another embodiment, the charger point 204 is adapted to provide an electrical connection between the charging station 104 and the electric vehicle. In yet another embodiment, the power distribution network 206 is adapted to couple the charger unit 202 to the charger point 204.

The message may comprise information in 8 bits. In an embodiment, the message comprises at least one of a vehicle identification (ID), battery mapping information, location of the electric vehicle, distance between the charging station and the electric vehicle, location of an external device of a user, and distance between the charging station and the external device. In another embodiment, the battery mapping information indicates the first portion, the second portion, and the third portion of the battery pack. In yet another embodiment, the battery mapping information comprises information regarding number of batteries in the battery pack.

In an embodiment, the battery pack comprises an individual battery comprising a plurality of cells. The first portion of the battery pack comprises a first plurality of cells among the plurality of cells of the battery pack. The second portion of the battery pack comprises a second plurality of cells among the plurality of cells of the battery pack. The third portion of the battery pack comprises a third plurality of cells among the plurality of cells of the battery pack. The first plurality of cells comprises degraded cells. The second plurality of cells comprises healthy cells. The third plurality of cells comprises moderate degraded cells. The first portion of the battery pack may comprise degraded cells of the battery pack. The second portion of the battery pack may comprise healthy cells of the battery pack. The third portion of the battery pack may comprise moderate degraded cells of the battery pack.

In another embodiment, the battery pack comprises at least one of a first battery, a second battery, and a third battery. The first battery may be a primary battery. The second battery may be a secondary battery. The third battery may be a tertiary battery. The first battery, the second battery, and the third battery may be identical batteries. The first battery, the second battery, and the third battery may be non-identical batteries. The primary battery may be a rechargeable battery. Similarly, the secondary battery and the tertiary battery may also be rechargeable batteries. In yet another embodiment, the first portion of the battery pack comprises a plurality of first cells from a combination of at least one of the first battery, the second battery, and the third battery. Similarly, the second portion and the third portion of the battery pack may comprise a plurality of second cells, and a plurality of third cells respectively, from a combination of at least one of the first battery, the second battery, and the third battery.

In an embodiment, the charging station 104, upon establishing a connection with the vehicle computer system of the electric vehicle 106, may extract/receive the charging time and the state-of-health information of the battery pack. The user may provide the charging time as an input to the charging station 104 via the vehicle computer system. In an embodiment, the user may provide the charging time as an input to the charging station 104 via an external device (e.g., a mobile, a computer, a laptop, a desktop, a tablet, a smart watch, and a personal digital assistant). In an embodiment, the charging time comprises a combination of at least one of a first charging time segment, a second charging time segment, and a third charging time segment. In an embodiment, the charging time may be split and provided as charging time segments by the user. In another embodiment, the charging station, via the artificial intelligence unit, automatically splits the charging time into charging time segments based on the state-of-health information and the charging time. In yet another embodiment, the charging station, via the artificial intelligence unit, automatically recommends the charging time segments based on the state-of-health information and the charging time to the user via the vehicle computer system. The user may then approve the recommendation through the vehicle computer system (infotainment system) or the external device 108.

In another embodiment, the external device 108 is configured to establish the connection with the charging station 104. In another embodiment, the external device 108 is configured to establish the connection with the vehicle computer system. In yet another embodiment, the connection comprises a wired connection. In yet another embodiment, the connection comprises a wireless connection. In yet another embodiment, the connection is configured to establish a two-way communication between the charging station 104 and the external device 108. The external device 108 is configured to communicate the update to the charging time to the vehicle computer system. The vehicle computer system communicates the update to the state-of-health information to the charging station 104.

The charging station 104 may receive the state-of-health information. The state-of-health information comprise a first state-of-health information, a second state-of-health information, and a third state-of-health information. The first state-of-health information may correspond to the first portion of the battery pack. The second state-of-health information may correspond to the second portion of the battery pack. The third state-of-health information may correspond to the third portion of the battery pack.

The charging station 104, via the control unit 210 and the artificial intelligence unit 208, determines a charging sequence based on the charging time and the state-of-health information. The charging station 104 may compute or determine the charging sequence as an optimal charging sequence. The charging sequence may be adapted to charge the battery pack at the maximum for the charging time provided. The charging sequence provides maximum charge to the battery pack during the charging time (i.e., allotted time) and to prevent damage to the battery pack.

In an embodiment, the charging station 104, via the artificial intelligence unit, recommends the charging sequence based on correlating the charging time and the state-of-health information of the battery pack with a previous history of the battery pack. The artificial intelligence unit may comprise a machine learning algorithm. The artificial intelligence unit analyse the message comprising the charging time and the state-of-health information of the battery pack. The artificial intelligence unit correlates the charging time and the state-of-health information of the battery pack with a previous history of the battery pack. The artificial intelligence unit then communicates a recommendation of the charging sequence to the control unit based on the analysis.

In yet another embodiment, the charging time comprises a combination of at least one of a first charging time segment, a second charging time segment, and a third charging time segment. In yet another embodiment, the charging sequence comprises a combination of at least one of a level 1 charging that corresponds to the first charging time segment, a level 2 charging that corresponds to the second charging time segment, and a level 3 charging that corresponds to the third charging time segment. In yet another embodiment, the charging sequence comprises a combination of at least one of a level 1 charging that corresponds to the first portion, a level 2 charging that corresponds to the second portion, and a level 3 charging that corresponds to the third portion of the battery pack. The level 1 charging may be a trickle charging. The level 2 charging may be a regular charging. The level 3 charging may be fast charging.

As an example, assume that the first portion, the second portion, and the third portion of the battery pack may comprise degraded cells, healthy cells, and moderate degraded cells, respectively. The charging station 104, via the control unit, determines the optimal charging sequence based on the state-of-health information and the charging time. The optimal charging sequence determined may assign the level 1 charging to the degraded cells, the level 2 charging to the moderate degraded cells and no charging to the degraded cells, respectively.

The control unit 210 is configured to determine the charging sequence to prevent damage to the battery pack and to provide the maximum charging to the battery pack during the charging time. The control unit communicates a signal to the charger unit. The signal may comprise information regarding the amount of power to be supplied to charge the battery pack of the vehicle. The signal may also comprise information regarding the charging sequence and the charging time. The charger unit 202 upon receiving the signal from the control unit 210 may supply the power to charge the battery pack.

In an embodiment, the artificial intelligence unit 208 is configured to analyze the charging time and the state-of-health information of the battery pack. The artificial intelligence unit 208 correlates the charging time and the state-of-health information of the battery pack with a previous history of the battery pack. The artificial intelligence unit 208 communicates a recommendation of the charging sequence to the control unit 210 based on the analysis. In another embodiment, the previous history of the battery pack comprises a plurality of charging times of the battery, a plurality of state-of-health information of the battery pack and a plurality of charging sequences.

In an embodiment, the artificial intelligence unit comprises a machine leaning model.

In an embodiment of the system, the machine learning model is configured to learn using labelled data using a supervised learning method, wherein the supervised learning method comprises logic using at least one of a decision tree, a logistic regression, a support vector machine, a k-nearest neighbors, a Naïve Bayes, a random forest, a linear regression, a polynomial regression, and a support vector machine for regression.

In an embodiment of the system, the machine learning model is configured to learn from the real-time data using an unsupervised learning method, wherein the unsupervised learning method comprises logic using at least one of a k-means clustering, a hierarchical clustering, a hidden Markov model, and an apriori algorithm.

In an embodiment of the system, the machine learning model has a feedback loop, wherein the output from a precious step is fed back to the model in real-time to improve the performance and accuracy of the output of a next step.

In an embodiment of the system, the machine learning model comprises a recurrent neural network model.

In an embodiment of the system, the machine learning model has a feedback loop, wherein the learning is further reinforced with a reward for each true positive of the output of the system.

In another aspect, a system is described herein. The system comprises a charging station 104. The charging station 104 is configured to charge an electric vehicle 106. The charging station 104 comprises a control unit 210. The control unit 210 is configured to establish a connection with an external device 108; receive an update to at least one of a charging time and state-of-health information from the external device; and modify a charging sequence and communicate a signal to a charger unit 202 to optimally ramp-up charging to the battery pack. The state-of-health information comprises a first state-of-health information that corresponds to a first portion of the battery pack, a second state-of-health information that corresponds to a second portion of the battery pack, and a third state-of-health information that corresponds to a third portion of the battery pack. The charging sequence comprises a combination of at least one of a level 1 charging, a level 2 charging, and a level 3 charging.

In yet another embodiment, the artificial intelligence unit 208 is configured to analyze the message comprising the update to the charging time and the state-of-health information of the battery pack. The artificial intelligence unit 208 correlates the update to charging time and the state-of-health information of the battery pack with a previous history of the battery pack. The artificial intelligence unit 208 then communicates a recommendation of the charging sequence to the control unit based on the analysis. In yet another embodiment, the previous history of the battery pack comprises a plurality of charging time of the battery pack, a plurality of state-of-health information of the battery pack and a plurality of charging sequence that the battery pack has undergone charging.

In yet another embodiment, the control unit 210 is configured to communicate a signal to the charger unit to supply the amount of power to provide the optimal charging sequence.

In yet another embodiment, the charging sequence comprises one of a level 1 charging, a level 2 charging, and a level 3 charging. In yet another embodiment, the charging sequence comprises a combination of at least one of a level 1 charging, a level 2 charging, and a level 3 charging. In yet another embodiment, the charging sequence comprises a combination of at least one of a level 1 charging that corresponds to the first portion of the battery pack, a level 2 charging that corresponds to the second portion of the battery pack, and a level 3 charging that corresponds to the third portion of the battery pack. In yet another embodiment, the charging sequence comprises a combination of at least one of a level 1 charging that corresponds to the first charging time segment, a level 2 charging that corresponds to the second charging time segment, and a level 3 charging that corresponds to the third charging time segment.

The level 1 charging may be a trickle charging. The level 2 charging comprises a regular charging. The level 3 charging comprises a fast charging. In an embodiment, the trickle charging comprises an input voltage of 120 volts alternating current (AC). The regular charging comprises an input voltage in a range between 208 volts to 240 volts alternating current (AC). The fast charging comprises an input voltage in a range between 400 volts to 900 volts direct current (DC).

In one embodiment, the battery pack comprises an individual battery. The individual battery comprises a plurality of cells. The first portion of the battery pack may comprise a first plurality of cells among the plurality of cells of the battery pack. The second portion of the battery pack may comprise a second plurality of cells among the plurality of cells of the battery pack. The third portion of the battery pack may comprise a third plurality of cells among the plurality of cells of the battery pack.

In another embodiment, the battery pack comprises at least one of a first battery, a second battery, and a third battery. The first battery may be a primary battery. The second battery may be a secondary battery. The third battery may be a tertiary battery. In this embodiment, the first portion of the battery pack comprises a plurality of cells from a combination of at least one of the first battery, the second battery, and the third battery.

In yet another embodiment, the control unit 210 is configured to receive the message comprising the update to the charging time from an external device. In yet another embodiment, the artificial intelligence unit 208 is configured to determine the charging time based on the state-of-health information of the battery pack via the vehicle computer system. In yet another embodiment, the artificial intelligence unit 208 is configured to recommend the charging time to a user through the vehicle computer system. In yet another embodiment, the artificial intelligence unit 208 is configured to recommend the charging time to a user through an external device.

In yet another embodiment, the vehicle computer system is configured to determine the charging time based on the state-of-health information of the battery pack. In yet another embodiment, the vehicle computer system is configured to determine the charging time based on the itinerary information of the user. In yet another embodiment, the vehicle computer system is configured to determine the charging time based on the information extracted from the calendar module of the external device. In yet another embodiment, the vehicle computer system is configured to determine the charging time based on the distance between the external device and the charging station. In yet another embodiment, the vehicle computer system is configured to determine the charging time based on the distance between the electric vehicle and the charging station and comparing with the travel itinerary. Based on the distance, the vehicle computer system determines the time needed for reaching the charging station. The vehicle computer system then estimates the arrival time of the electric vehicle at the charging station. The vehicle computer system then compares the arrival time with the next departure time from the travel itinerary and determines the charging time.

In yet another aspect, a non-transitory storage medium is described herein. The non-transitory storage medium stores a sequence of instructions, which when executed by a processor cause: establishing a connection between the charging station and a vehicle computer system; receiving a message comprising a charging time from the vehicle computer system; extracting state-of-health information of a battery pack through the vehicle computer system via the connection established; and determining a charging sequence and communicating a signal to a charger unit to optimally ramp-up charging to the battery pack. The state-of-health information comprises a first state-of-health information that corresponds to a first portion of the battery pack, a second state-of-health information that corresponds to a second portion of the battery pack, and a third state-of-health information that corresponds to a third portion of the battery pack. The charging sequence comprises a combination of at least one of a level 1 charging, a level 2 charging, and a level 3 charging.

In yet another aspect, a non-transitory storage medium is described herein. The non-transitory storage medium stores a sequence of instructions, which when executed by a processor cause: establishing a connection between the charging station and an external device; receiving an update to at least one of a charging time and state-of-health information from the external device; and modifying a charging sequence and communicating a signal to a charger unit to optimally ramp-up charging to the battery pack. The charging sequence comprises a combination of at least one of a level 1 charging, a level 2 charging, and a level 3 charging. The state-of-health information comprises a first state-of-health information that corresponds to a first portion of the battery pack, a second state-of-health information that corresponds to a second portion of the battery pack, and a third state-of-health information that corresponds to a third portion of the battery pack.

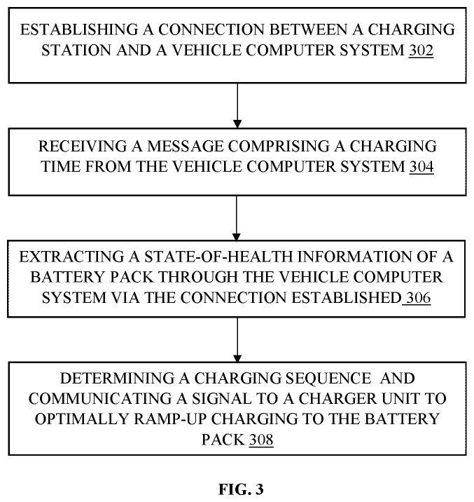

In yet another aspect, a method is described herein. As an example, FIG. 3 illustrates a method of optimal timed charging, according to one or more embodiments. The method comprises:
Step 302: establishing, by a charging station, a connection between the charging station and a vehicle computer system;
Step 304: receiving, by the charging station, a message comprising a charging time from the vehicle computer system;
Step 306: extracting, by the charging station, state-of-health information of a battery pack through the vehicle computer system via the connection established; and
Step 308: determining, by the charging station, a charging sequence and communicating a signal to a charger unit to optimally ramp-up charging to the battery pack.

In an embodiment, the charging sequence comprises a combination of at least one of a level 1 charging, a level 2 charging, and a level 3 charging. In another embodiment, the state-of-health information comprises a first state-of-health information that corresponds to a first portion of the battery pack, a second state-of-health information that corresponds to a second portion of the battery pack, and a third state-of-health information that corresponds to a third portion of the battery pack.

In an embodiment, the charging station may receive a message comprising an update to at least one of the charging time and the state-of-health information from the vehicle computer system. In another embodiment, the user may provide the update to the charging time via a user interface (e.g., touch screen) of the vehicle computer system. In another embodiment, the user may provide the update to the charging time using an external device (e.g., mobile phone) via the vehicle computer system. In another embodiment, the user may provide the update to the charging time directly using an external device (e.g., mobile phone) to the charging station 104.

In another embodiment, the user may provide the input as voice input. The vehicle computer system, using artificial intelligence/machine learning, analyzes the voice input. The artificial intelligence unit 208 may comprise a machine learning unit. The vehicle computer system may also use a natural language processing technique to analyze and learn the voice input. As an example, consider the user has provided the voice input as “Coffee” to the vehicle computer system. The vehicle computer system analyzes the voice input and determines the time needed for that event (i.e., having a coffee). The vehicle computer system provides the determined time as the charging time to the charging station. The vehicle computer system, using artificial intelligence/machine learning, compares and matches the voice input with previous voice input. Based on the comparison, the vehicle computer system determines the charging time. In an embodiment, the natural language processing technique is capable of analyzing and determining the charging time from the voice input provided in a multilingual format.

As another example, consider the user has provided the voice input as “Lunch” to the vehicle computer system. The vehicle computer system, using artificial intelligence/machine learning, analyzes the voice input. The vehicle computer system may also use a natural language processing technique to analyze and learn the voice input. The vehicle computer system analyzes the voice input and determines the time needed for that event (i.e., having lunch). The vehicle computer system compares and matches the voice input with previous voice input. Based on the comparison, the vehicle computer system determines the charging time. In an embodiment, the vehicle computer system also determines a nearby restaurant by communicating with a database. The vehicle computer system extracts the list of nearby restaurants from a database and determines the appropriate nearby restaurant based on the location of the electric vehicle and/or the external device. Based on the appropriate restaurant determined, the vehicle computer system may modify the determined time. For example, In a restaurant like Burger King®, the time for having lunch (e.g., Burger) is 5 minutes, whereas the time for having lunch (e.g., an Indian rice meal) in an Indian Restaurant is approx. 25 minutes. The charging station may determine the charging time based on not only the voice input but also the surrounding circumstances (e.g., location, event, time incurred for that event, availability of services in that location, traffic, etc.) of the user.

In another embodiment, the vehicle computer system determines the charging time based on a travel itinerary of the user. The user while planning the travel may allot time for food and beverages as well as for relaxation. The user may prepare the travel itinerary. The charging station, upon establishing a connection with the vehicle computer system, may extract the allotted time from the travel itinerary and receive the allotted time as the charging time from the vehicle computer system. In yet another embodiment, the charging station determines the charging time based on a travel itinerary of the user. The charging station, upon establishing a connection with the vehicle computer system, may extract the travel itinerary and determine the allotted time (e.g., the time for food and beverages and/or relaxation) as the charging time.

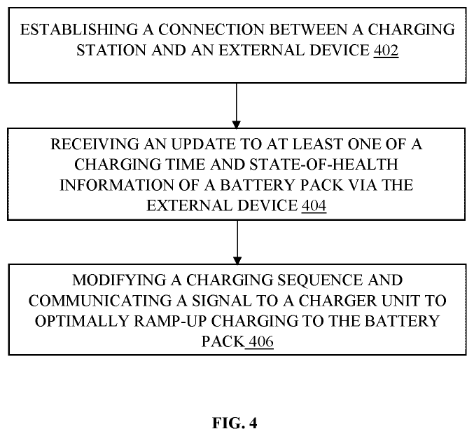

In yet another aspect, a method is described herein. As an example, FIG. 4 illustrates a method of optimal timed charging involving an external device, according to one or more embodiments. The method comprises:
Step 402: establishing, by a charging station, a connection between the charging station and an external device;
Step 404: receiving, by the charging station, an update to at least one of a charging time and state-of-health information from the external device; and
Step 406: modifying, by the charging station, a charging sequence and communicating a signal to a charger unit to optimally ramp-up charging to the battery pack.

In an embodiment, the charging sequence comprises a combination of at least one of a level 1 charging, a level 2 charging, and a level 3 charging. In another embodiment, the state-of-health information comprises a first state-of-health information that corresponds to a first portion of the battery pack, a second state-of-health information that corresponds to a second portion of the battery pack, and a third state-of-health information that corresponds to a third portion of the battery pack.

In an embodiment, the connection may be a bi-directional communication. The connection may be established through wired communication technology. In another embodiment, the connection may be established through wireless communication technology.

The update to the charging time may be an addition of predefined time (e.g., +5 minutes, +10 minutes, +15 minutes, etc.) to the existing charging time. In an embodiment, the update to the charging time may be altogether providing a new charging time. The user may provide the update to the charging time to the charging station 104 via the vehicle computer system. In an embodiment, the user may provide the update to the charging time to the charging station 104 using an external device.

The vehicle computer system may determine the state-of-health information while the battery pack is connected to the charging station 104. The vehicle computer system monitors the state-of-health information of the battery pack and provides the update to the state-of-health information with respect to different portions of the battery pack to the charging station 104 via the external device. In an embodiment, the vehicle computer system communicates the update to at least one of the charging time and the state-of-health information of the battery pack from to the charging station 104 via the external device at a first event. The first event may be a situation where the battery pack has not reached a threshold charging level. The first event may also be a situation where the state-of-health information of the battery pack is critical. The artificial intelligence unit 208 may determine the occurrence of the first event and notify the vehicle computer system and/or the external device. The vehicle computer system upon receiving the notification may provide the update to the state-of-health information. The vehicle computer system may determine and provide the update to the charging time to the charging station. In an embodiment, the vehicle computer system determines the update to the charging time based on a distance between a location of the external device (e.g., mobile phone, handset, personal digital assistant (PDA), laptop, tablet, etc.) and the charging station. In another embodiment, the charging station 104 itself may determine the update to the charging time based on a distance between a location of the external device (e.g., mobile phone, handset, personal digital assistant (PDA), laptop, tablet, etc.) and the charging station. In yet another embodiment, the charging station 104 may determine the update to the charging time based on the state-of-health information The charging station 104 upon receiving the update to the charging time and the state-of-health information may modify the charging sequence. The charging station 104 may modify the supplied power based on the modified charging sequence.

For example, consider the charging station 104 has initially received the message comprising the charging time. The charging station 104 may extract the state-of-health information through the vehicle computer system. The charging station 104 then may compute an optimal charging sequence based on the charging time and the state-of-health information. The charging sequence may comprise different levels of charging corresponding to different portions of the battery pack and different charging time segments. The charging station 104 then determines the amount of power to be supplied to optimally ramp-up the charging to the electric vehicle. The charging station 104 is then capable of receiving an update to at least one of the charging time and the state-of-health information. The external device may communicate the update to at least one of the charging time and the state-of-health information. The external device may determine the distance between the location of the external device and the charging station. The external device then determines the time for the user to reach the charging station based on the distance calculated. The external device communicates the time as the update to the charging time.

In an embodiment, the update to the charging time may be less than the charging time initially provided. The charging station 104 meanwhile extracts or receives the update to the state-of-health information from the vehicle computer system. The charging station 104 then modifies the charging sequence. In this case, the charging station may change the charging sequence from regular charging or trickle charging to supercharging. The modified charging sequence may provide supercharging to the healthy cells rather than degraded cells of the battery pack to prevent damage to the battery. The charging station may also notify an alert to the user via the vehicle computer system or the external device. The alert may comprise a warning message that unplugging the electric vehicle prior to the charging time may damage the battery pack.

In another embodiment, the update to the charging time may be greater than the charging time initially provided. The charging station computes the modified charging sequence. In this case, the charging station may change the charging sequence from supercharging to regular charging or trickle charging. The modified charging sequence may provide regular charging to the healthy cells rather than degraded cells of the battery pack to prevent damage to the battery.

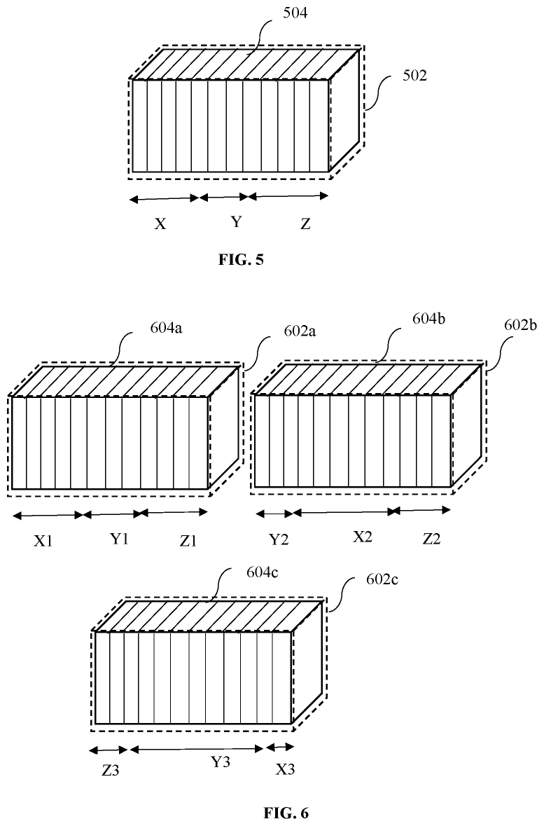

As an example, FIG. 5 illustrates a battery pack 502 comprising an individual battery, according to one or more embodiments. The battery pack 502 herein comprises an individual battery. The battery comprises a plurality of cells 504. The battery pack comprises a first portion X, a second portion Y, and a third portion Z. The first portion X may comprise a first plurality of cells among the plurality of cells of the battery. The second portion Y may comprise a second plurality of cells among the plurality of cells of the battery. The third portion Z may comprise a third plurality of cells among the plurality of cells of the battery.

The first portion X, the second portion Y, and the third portion Z may be categorized based on the state-of-health information at the respective portions. The first portion X may comprise a first state-of-health information. The second portion Y may comprise a second state-of-health information. The third portion Z may comprise a third state-of-health information. In an embodiment, the first portion may refer to a portion of the battery having degraded cells. The second portion may refer to a portion of the battery having healthy cells. The third portion may refer to a portion of the battery having moderate degraded cells.

As an example, FIG. 6 illustrates a battery pack comprising a plurality of batteries, according to one or more embodiments. The battery pack herein comprises a first battery 602a, a second battery 602b, and a third battery 602c. The first battery 602a may comprise a plurality of first cells 604a. The second battery 602b may comprise a plurality of second cells 604b. The third battery 602c may comprise a plurality of third cells 604c. Each battery of the battery pack is connected electrically to get charged. The charging station charges each battery of the battery pack. The charging station may charge each battery of the battery pack through one of randomly, serially, and parallelly.

The charging station may charge at least one of a first portion X, a second portion X, and a third portion Z of the battery pack. The first portion X of the battery pack refers to degraded cells from each battery of the battery pack (X=X1+X2+X3). The second portion Y of the battery pack refers to healthy cells from each battery of the battery pack (Y=Y1+Y2+Y3). The third portion Z of the battery pack refers to moderate degraded cells from each battery of the battery pack (Z=Z1+Z2+Z3). Healthy cells may be contiguous or non-contiguously located within the same battery. Similarly, degraded, and moderate degraded cells may be contiguous or non-contiguously located within the same battery.

The charging station is configured to map the battery pack based on the state-of-health information. In an embodiment, the charging station maps at least one of the degraded cells, the healthy cells, and the moderate degraded cells of the battery pack. The charging station, upon performing mapping the battery pack, computes a charging sequence based on the state-of-health information and the charging time. The charging station may assign the charging sequence to a particular portion of the battery pack. In an embodiment, the charging station assigns the charging sequence to only the healthy cells and the moderate degraded cells of the battery pack. The charging station may ignore charging to the degraded cells.

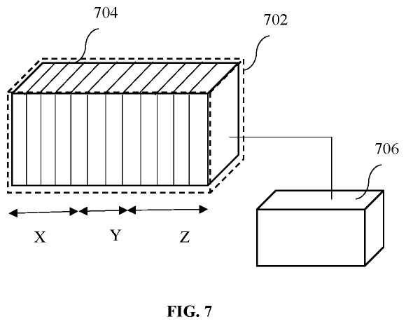

As an example, FIG. 7 schematically shows a battery pack comprising a battery 702 and a battery management system 706, according to one or more embodiments. The battery 702 in turn comprises a plurality of cells 704. The battery management system 706 may include a microprocessor, microcontroller, programmable digital signal processor, or another programmable device. The battery management system 706 may also or alternatively comprise an application specific integrated circuit, a programmable gate array or programmable array logic, a programmable logic device or a digital signal processor. Where the battery management system 706 comprises a programmable device such as the microprocessor, microcontroller or programmable digital signal processor mentioned above, the processor may also comprise computer executable code which controls the operation of the programmable device. In an embodiment, the battery management system 706 resides within an electric vehicle. The battery management system 706 determines the state-of-health (SoH) of the battery pack and communicates to the charging station via a vehicle computer system.

In an embodiment, the battery management system 706 is configured to: measure a first battery property and a battery temperature of a battery in the electric vehicle; calculating the state-of-health (SoH) of the battery cell for the determined battery attributes using a predetermined model_{calc}(ii) a Providing a function f for estimating the cell degradation rate; updating the state-of-health estimated in the previous time step according to: SoHest←SoHest+f·dt+K·(SoHcalc−SoHest) where K is a gain factor that depends on the operating conditions of the vehicle, and where K is modified using a reinforcement learning agent for each time step.

In another embodiment, the battery management system 706 estimates State-of-health (SOH) characteristics of a battery pack in a hybrid vehicle. The estimation of the SOH includes: charging and discharging the battery pack at least one time within an upper region of State-of-charge (SOC) window. In this case, the battery pack is charged to a first predetermined level in the upper region of the SOC window during a first time period. A first charge current impulse then charges the battery pack for pushing the SOC level of the battery pack to a level above the first predetermined level and outside the SOC window, during a second time period. An electrical machine then discharges the battery pack to a second predetermined level within the SOC window.

The estimation of the SOH further includes: charging and discharging the battery pack at least one time within a lower region of the SOC window. In this case, the battery pack is charged to a third predetermined level in the SOC window, during a third time period. An electrical machine then discharges the battery pack to a fourth predetermined level in the SOC window. A second current impulse then discharges the battery pack, for pushing the SOC level of the battery pack to a level below the fourth predetermined level and below the SOC window, during a fourth time period.

The estimation of the SOH further includes: calibrating by the battery management system 706 comprised in the hybrid vehicle by using the reached levels outside the SOC window for determining correct upper and lower edges of the current soc window; and estimating the SOH characteristics of the battery pack during the charge and discharge periods by using the battery management system 706 for determining the condition of the battery pack in comparison to a new and unused battery pack by comparing the current SOC window with a standard SOC window. In an embodiment, the first and third time period is longer than the second and fourth time period, respectively. In another embodiment, the first predetermined level represents a higher voltage, than the second predetermined level and the third predetermined level represents a higher voltage, than the fourth predetermined level.

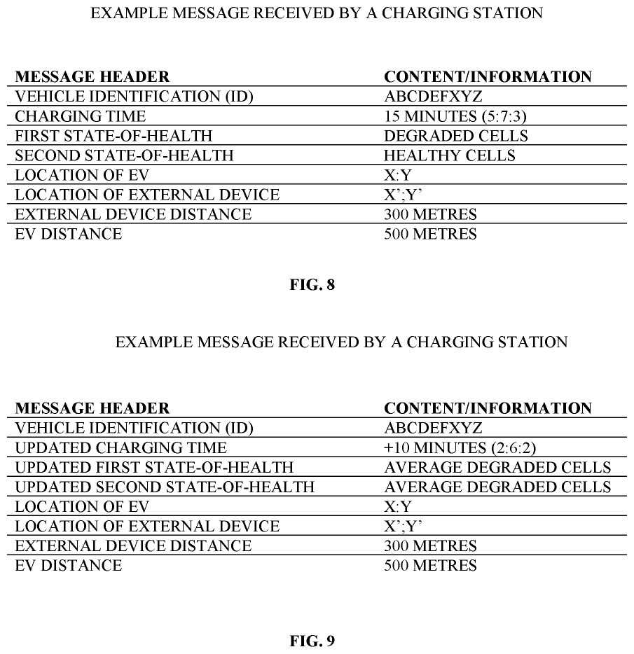

As an example, FIG. 8 illustrates a message received by a charging station, according to one or more embodiments. In an embodiment, the message is similar to HL7 protocol. The message may comprise 0 to 8 bits. The sample message shown in FIG. 8 comprises fields such as vehicle ID, charging time, first state-of-health, second state-of-health, location of electric vehicle, location of external device, distance between external device and charging station, and distance between charging station and EV.

The vehicle ID may be a serial identification number, or a tag associated with the electric vehicle configured to identify and locate the electric vehicle. The charging time may be the allotted time provided for optimally charging the vehicle. The first state-of-health, and the second state-of-health refers to state-of-health information of different portions of the battery pack. The location of the electric vehicle indicates the current location of the electric vehicle. The location of the external device indicates a current location of the external device, which in turn refers to a location of the user. The charging station upon receiving the message decodes and extracts the information for charging the electric vehicle. The charging station then may supply power according to the information received via the message to optimally charge the electric vehicle for the allotted time.

As an example, FIG. 9 illustrates a message, with an update to the charging time, received by a charging station, according to one or more embodiments. In an embodiment, the message is similar to HL7 protocol. The message may comprise 0 to 8 bits. The sample message shown in FIG. 9 comprises fields such as vehicle ID, updated charging time, updated first state-of-health, updated second state-of-health, location of electric vehicle, location of external device, distance between external device and charging station, and distance between charging station and EV.

The vehicle ID may be a serial identification number, or a tag associated with the electric vehicle configured to identify and locate the electric vehicle. The updated charging time may be the allotted time modified for optimally charging the vehicle. The updated first state-of-health, and the updated second state-of-health refers to modified state-of-health information of different portions of the battery pack. The location of the electric vehicle indicates a current location of the electric vehicle. The location of the external device indicates the current location of the external device, which in turn refers to a location of the user. The charging station upon receiving the message decodes and extracts the information for charging the electric vehicle. The charging station then may modify the supplied power according to the information received via the message to optimally charge the electric vehicle for the allotted time.

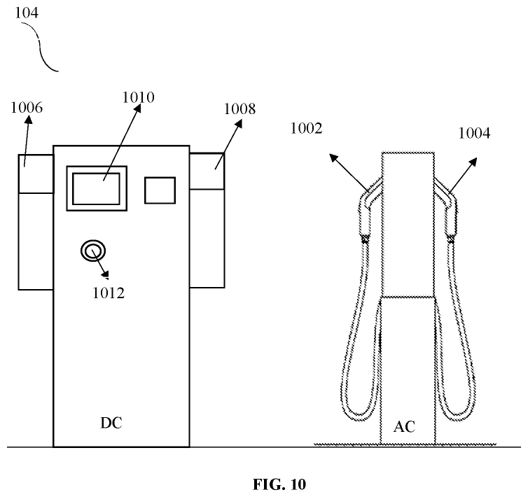

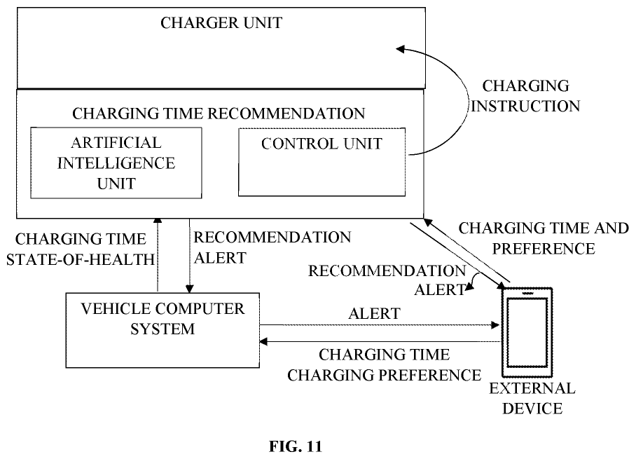

As an example, FIG. 10 shows a schematic diagram of a charging station 104, according to one or more embodiments. In this embodiment, the charging station 104 comprises at least two or more connector interfaces to allow power delivery to Electric vehicles with any one or more matching plug type. The charging station 104 includes a first connector 1002, a second connector 1004, a third connector 1006, and a fourth connector 1008. The connector location depicted by the drawing is for illustration only and does not solidify a design specification, i.e., the plug type and side location may be changed if needed. The charging station 104 has the ability to deliver both Level 3 DC to DC quick charge and Level 2 AC to DC (up to 70 Amps delivery). The charging station 104 can charge at least two Electric vehicles simultaneously.

The charging station 104 includes a touch screen device 1010 that allows the consumer/user to receive, send, and interact with web-delivered media and content. The touch screen device 1010 includes a 15 inch (diagonal) or larger touch screen. An interface is interconnected with the charging station 104 using Web portal, Small Business Portal, mobile app services and the like. The charging station 104 further comprises a button 1012 that allows a consumer/user to select an item displayed on the touch screen device 1010. The button 1012 is an activator that causes selected web content to be sent to a mobile application on the consumer's/user's external device (e.g., phone). The button 1012 may be a physical depressible button or a screen-represented button.

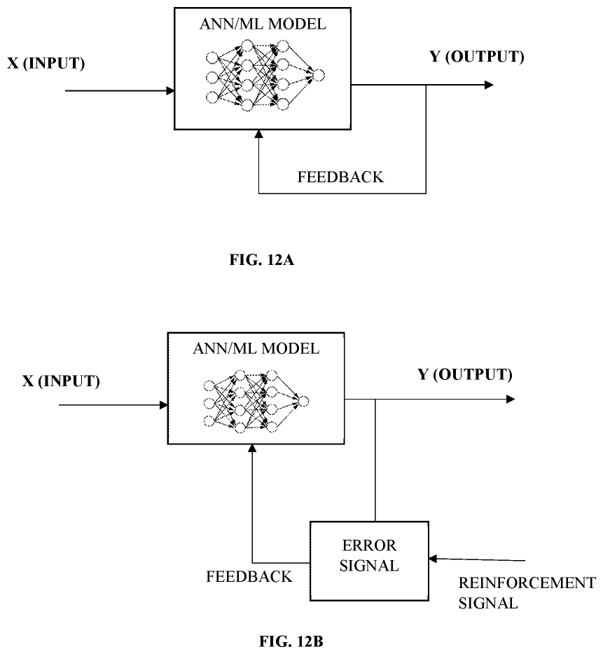

As an example, FIG. 11, provides a depiction of data flow between a charging station, a vehicle computer system, and an external device, according to one or more embodiments. The external device sends charging time and the charging preference either to the vehicle computer system or directly to the control unit of the charging station. The vehicle computer system sends state of charge information and the state-of-health information together with the charging preference and the charging time to the charging station. The artificial intelligence unit analyzes the data received from the vehicle computer system and the available options at the charging station to recommend charging time and the rate of charge that charges the battery pack maximally in the charging time and is suitable for the health of the battery. The analysis result is sent to the charger via the control unit of the charging station. In another embodiment, the artificial intelligence unit may provide recommendations of either changing the charging preference that is suitable for charging the battery pack to maximum in the allotted time or it may recommend increasing the charging time if the cost at the station is lesser or if extra perks are provided by the charging station.

In an embodiment, the artificial intelligence unit uses data flow graphs by sorting through data layers called nodes to make decisions based on rules and output statistics and predictive analysis using a large dataset of labeled and unlabeled data in an artificial intelligence unit library. Large sets of algorithms allow for improved deep learning, overall performance, accuracy, and speed. The artificial intelligence unit, running the RNN models, supports machine learning algorithms such as classification, regression, and clustering.

In an embodiment, a high-performance AI engine based on RNN can constantly analyze and compare both large numerical datasets of available labeled and unlabeled data.

In an embodiment, a neural network creates predictions based on existing data. A neural network consists of: (1) input layers that take inputs based on existing data, (2) hidden layers that use backpropagation to optimize the weights of the input variables to improve the predictive accuracy of the model, and (3) output layers that are the output of predictions based on the analyzed data from the input and hidden layers.

In an embodiment, deep learning approach begins with generating optimal algorithms at a completely random and ground level. The learning data is characterized to include a multitude of the developed fundamental algorithms. Most of the algorithms can be individually insufficient and sparse and individually seem limited and therefore some code can be found to be better than the rest. These pieces are then to be collectively used in the deep learning model. As new sets of algorithms get generated, that are continuously trialed, and this process keeps repeating until such an optimal set of algorithms are found that is better than anything else at solving the problem and thereby output the most desirable optimal analysis.

FIG. 12A shows a structure of the neural network/machine learning model with a feedback loop, according to one or more embodiments. Artificial neural networks (ANNs) model comprises an input layer, one or more hidden layers, and an output layer. Each node, or artificial neuron, connects to another and has an associated weight and threshold. If the output of any individual node is above the specified threshold value, that node is activated, sending data to the next layer of the network. Otherwise, no data is passed to the next layer of the network. A machine learning model or an ANN model may be trained on a set of data to take a request in the form of input data (e.g., message received by the charging station or the charging system), make a prediction on that input data, and then provide a response. The model may learn from the data. Learning can be supervised learning and/or unsupervised learning and may be based on different scenarios and with different datasets. Supervised learning comprises logic using at least one of a decision tree, logistic regression, support vector machines. Unsupervised learning comprises logic using at least one of a k-means clustering, a hierarchical clustering, a hidden Markov model, and an apriori algorithm. The output layer may predict or detect or determine at least one of a charge consumption rate, a change in state-of-health of charging system, change in driving pattern, or change in driving mode, a required charging sequence to maintain a state of charge, a modified charging sequence, an update to charging time, an update to state-of-health information, amount of power etc. based on the input data. The input data may comprise one or more of a charging time, user input (e.g., voice input, text input, etc.), battery consumption rate, environmental factors affecting the battery performance, change in route, weather condition, road condition, traffic condition, a driving pattern, and a driving mode.

In an embodiment, ANN's may be a Deep-Neural Network (DNN), which is a multilayer tandem neural network comprising Artificial Neural Networks (ANN), Convolution Neural Networks (CNN) and Recurrent Neural Networks (RNN) that can recognize features from inputs, do an expert review, and perform actions that require predictions, creative thinking, and analytics. In an embodiment, ANNs may be Recurrent Neural Network (RNN), which is a type of Artificial Neural Networks (ANN), which uses sequential data or time series data. Deep learning algorithms are commonly used for ordinal or temporal problems, such as language translation, Natural Language Processing (NLP), speech recognition, and image recognition, etc. Like feedforward and convolutional neural networks (CNNs), recurrent neural networks utilize training data to learn. They are distinguished by their “memory” as they take information from prior input via a feedback loop to influence the current input and output. An output from the output layer in a neural network model is fed back to the model through the feedback. The variations of weights in the hidden layer(s) will be adjusted to fit the expected outputs better while training the model. This will allow the model to provide results with far fewer mistakes.

The neural network is featured with the feedback loop to adjust the system output dynamically as it learns from the new data. In machine learning, backpropagation and feedback loops are used to train an AI model and continuously improve it upon usage. As the incoming data that the model receives increases, there are more opportunities for the model to learn from the data. The feedback loops, or backpropagation algorithms, identify inconsistencies and feed the corrected information back into the model as an input.

Even though the AI/ML model is trained well, with large sets of labelled data and concepts, after a while, the models' performance may decline while adding new, unlabelled input due to many reasons which include, but not limited to, concept drift, recall precision degradation due to drifting away from true positives, and data drift over time. A feedback loop to the model keeps the AI results accurate and ensures that the model maintains its performance and improvement, even when new unlabelled data is assimilated. A feedback loop refers to the process by which an AI model's predicted output is reused to train new versions of the model.

Initially, when the AI/ML model is trained, a few labelled samples comprising both positive and negative examples of the concepts (for e.g., charging rate, charging pattern, charging sequences, amount of power, etc.) are used that are meant for the model to learn. Afterward, the model is tested using unlabelled data. By using, for example, deep learning and neural networks, the model can then make predictions on whether the desired concept/s (for e.g., charging rate, charging pattern, charging sequences, amount of power, etc.) are in unlabelled images. Each image is given a probability score where higher scores represent a higher level of confidence in the models' predictions. Where a model gives an image a high probability score, it is auto labelled with the predicted concept. However, in the cases where the model returns a low probability score, this input may be sent to a controller (may be a human moderator) which verifies and, as necessary, corrects the result. The human moderator may be used only in exception cases. The feedback loop feeds labelled data, auto-labelled or controller-verified, back to the model dynamically and is used as training data so that the system can improve its predictions in real-time and dynamically.

FIG. 12B shows a structure of the neural network/machine learning model with reinforcement learning, according to one or more embodiments. The network receives feedback from authorized networked environments. Though the system is similar to supervised learning, the feedback obtained in this case is evaluative not instructive, which means there is no teacher as in supervised learning. After receiving the feedback, the network performs adjustments of the weights to get better predictions in the future. Machine learning techniques, like deep learning, allow models to take labeled training data and learn to recognize those concepts in subsequent data and images. The model may be fed with new data for testing, hence by feeding the model with data it has already predicted over, the training gets reinforced. If the machine learning model has a feedback loop, the learning is further reinforced with a reward for each true positive of the output of the system. Feedback loops ensure that AI results do not stagnate. By incorporating a feedback loop, the model output keeps improving dynamically and over usage/time.

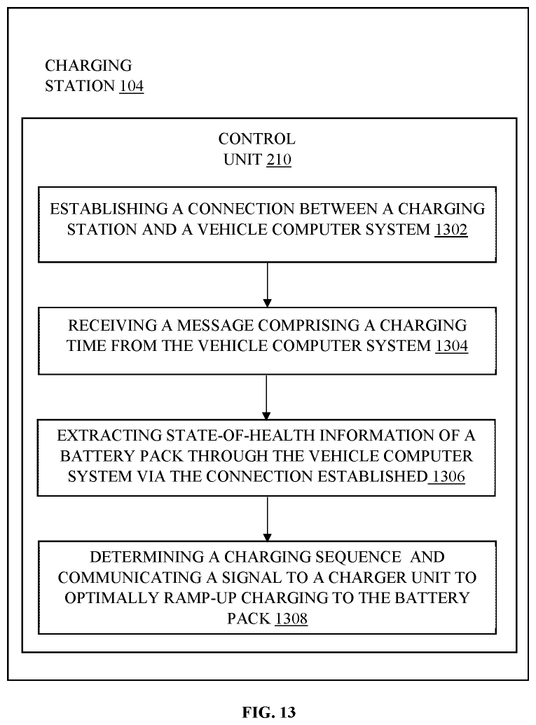

As an example, FIG. 13 illustrates a system, according to one or more embodiments. The system comprises a charging station 104. The charging station 104 is configured to charge an electric vehicle. The charging station 104 comprises a control unit 210. The control unit 210 is configured to at least perform the following technical steps:
Step 1302: establishing a connection between the charging station and a vehicle computer system;
Step 1304: receiving a message comprising a charging time from the vehicle computer system;
Step 1306: extracting state-of-health information of a battery pack through the vehicle computer system via the connection established; and
Step 1308: determining a charging sequence and communicating a signal to a charger unit to optimally ramp-up charging to the battery pack.

In an embodiment, the charging sequence comprises a combination of at least one of a level 1 charging, a level 2 charging, and a level 3 charging. In another embodiment, the state-of-health information comprises a first state-of-health information that corresponds to a first portion of the battery pack, a second state-of-health information that corresponds to a second portion of the battery pack, and a third state-of-health information that corresponds to a third portion of the battery pack.

In an embodiment, the charging station 104 may receive a message comprising an update to at least one of the charging time and the state-of-health information from the vehicle computer system. In another embodiment, the user may provide the update to the charging time via a user interface (e.g., touch screen) of the vehicle computer system. The charging station 104 then may modify the charging sequence based on the update.

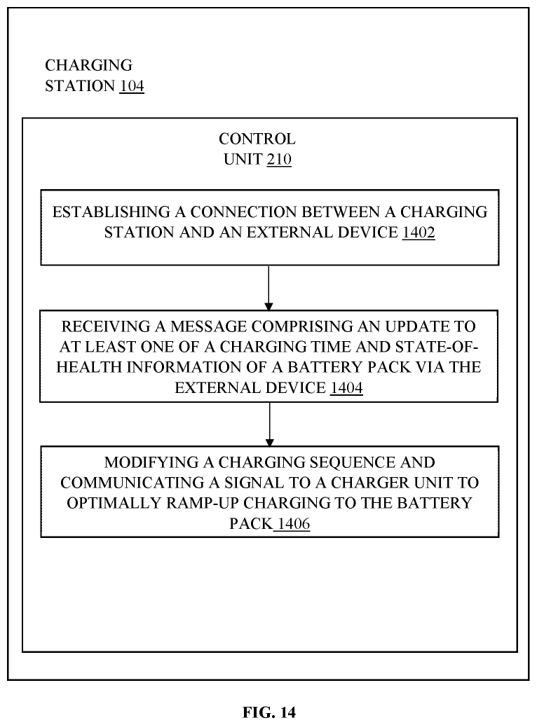

As an example, FIG. 14 illustrates a system, according to one or more embodiments. The system comprises a charging station 104. The charging station 104 is configured to charge an electric vehicle. The charging station 104 comprises a control unit 210. The control unit 210 is configured to at least perform the following technical steps:
Step 1402: establishing a connection between the charging station and an external device;
Step 1404: receiving a message comprising an update to at least one of a charging time and state-of-health information via the external device; and
Step 1406: modifying a charging sequence and communicating a signal to a charger unit to optimally ramp-up charging to the battery pack.

In an embodiment, the charging sequence comprises a combination of at least one of a level 1 charging, a level 2 charging, and a level 3 charging. In another embodiment, the state-of-health information comprises a first state-of-health information that corresponds to a first portion of the battery pack, a second state-of-health information that corresponds to a second portion of the battery pack, and a third state-of-health information that corresponds to a third portion of the battery pack.

In an embodiment, the connection may be a bi-directional communication. The connection may be established through wired communication technology. In another embodiment, the connection may be established through wireless communication technology.

The update to the charging time may be an addition of predefined time (e.g., +5 minutes, +10 minutes, +15 minutes, etc.) to the existing charging time. In an embodiment, the update to the charging time may be altogether providing a new charging time. The user may provide the update to the charging time to the charging station 104 via the vehicle computer system. In an embodiment, the user may provide the update to the charging time to the charging station 104 using an external device.

The vehicle computer system may determine the state-of-health information while the battery pack is connected to the charging station 104. The vehicle computer system monitors the state-of-health information of the battery pack and provides the update to the state-of-health information with respect to different portions of the battery pack to the charging station 104 via the external device. The charging station 104 then may modify the charging sequence based on the update received.

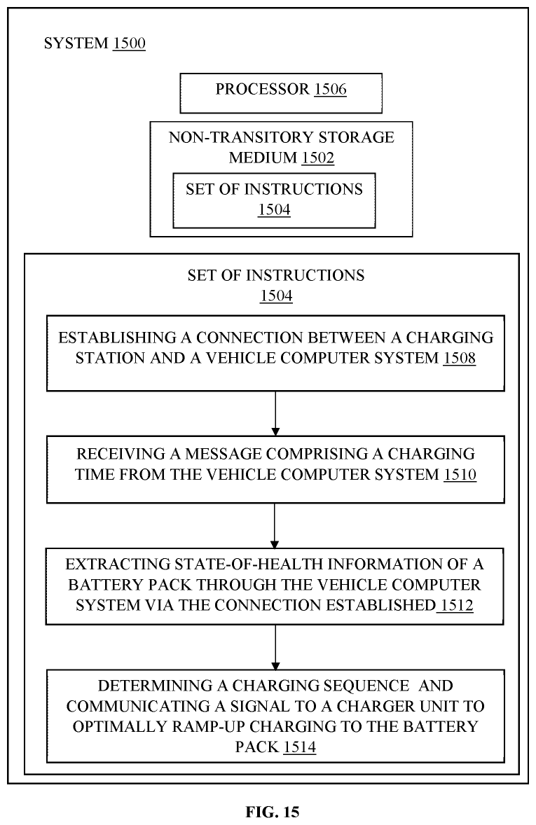

As an example, FIG. 15 illustrates a system 1500, according to one or more embodiments. The system 1500 comprises a non-transitory storage medium 1502 and a processor 1506. The non-transitory storage medium 1502 comprises a set of instructions 1504. The set of instructions 1504 is executed by the processor 1506 to at least perform the following technical steps:
Step 1508: establishing a connection between a charging station and a vehicle computer system;
Step 1510: receiving a message comprising a charging time from the vehicle computer system;
Step 1512: extracting state-of-health information of a battery pack through the vehicle computer system via the connection established; and
Step 1514: determining a charging sequence and communicating a signal to a charger unit to optimally ramp-up charging to the battery pack.

In an embodiment, the charging sequence comprises a combination of at least one of a level 1 charging, a level 2 charging, and a level 3 charging. In another embodiment, the state-of-health information comprises a first state-of-health information that corresponds to a first portion of the battery pack, a second state-of-health information that corresponds to a second portion of the battery pack, and a third state-of-health information that corresponds to a third portion of the battery pack.

In an embodiment, the charging station 104 may receive a message comprising an update to at least one of the charging time and the state-of-health information from the vehicle computer system. In another embodiment, the user may provide the update to the charging time via a user interface (e.g., touch screen) of the vehicle computer system. In another embodiment, the user may provide the update to the charging time using an external device (e.g., mobile phone) via the vehicle computer system.

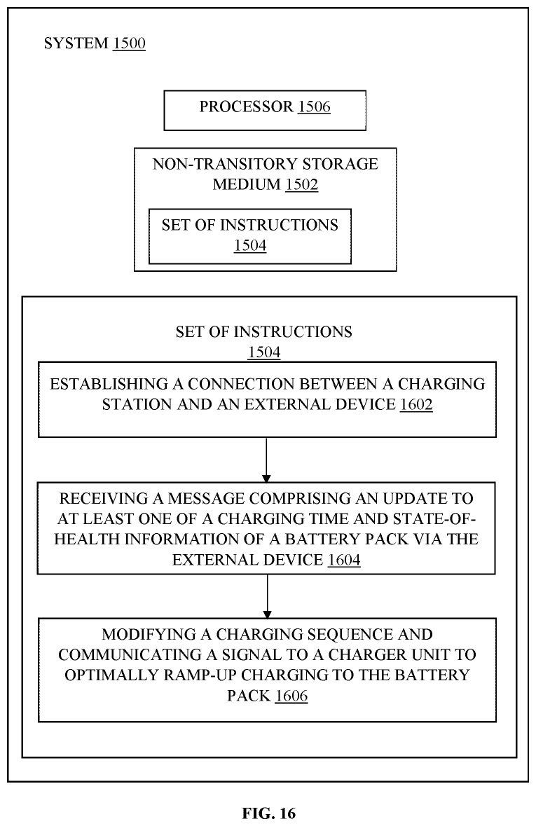

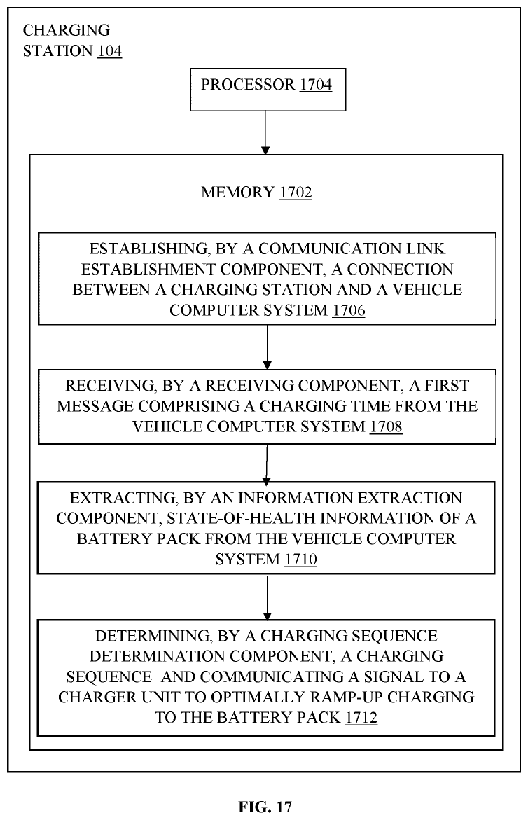

As an example, FIG. 16 illustrates a system 1500, according to one or more embodiments. The system 1500 comprises a non-transitory storage medium 1502 and a processor 1506. The non-transitory storage medium 1502 comprises a set of instructions 1504. The set of instructions 1504 is executed by the processor 1506 to at least perform the following technical steps:
Step 1602: establishing a connection between the charging station and an external device;
Step 1604: receiving a message comprising an update to at least one of a charging time and state-of-health information from the external device; and
Step 1606: modifying a charging sequence and communicating a signal to a charger unit to optimally ramp-up charging to the battery pack.

In an embodiment, the charging sequence comprises a combination of at least one of a level 1 charging, a level 2 charging, and a level 3 charging. In another embodiment, the state-of-health information comprises a first state-of-health information that corresponds to a first portion of the battery pack, a second state-of-health information that corresponds to a second portion of the battery pack, and a third state-of-health information that corresponds to a third portion of the battery pack.

In an embodiment, the connection may be a bi-directional communication. The connection may be established through wired communication technology. In another embodiment, the connection may be established through wireless communication technology.

The update to the charging time may be an addition of predefined time (e.g., +5 minutes, +10 minutes, +15 minutes, etc.) to the existing charging time. In an embodiment, the update to the charging time may be altogether providing a new charging time.

As an example, FIG. 17 illustrates a system performing an optimal timed charging, according to one or more embodiments. The system comprises a charging station 104. The charging station 104 comprises a memory 1702 that stores computer executable components. The charging station 104 further comprises a processor 1704 that executes the computer executable components stored in the memory. The computer executable components comprise a communication link establishment component, a receiving component, an information extraction component, and a charging sequence determination component. The computer executable components configured to perform the following technical steps:
Step 1706: establishing, by the communication link establishment component, a connection between the charging station and a vehicle computer system. The connection may be a bi-directional communication connection;
Step 1708: receiving, by a receiving component, a first message comprising a charging time from the vehicle computer system;
Step 1710: extracting, by an information extraction component, state-of-health information of a battery pack from the vehicle computer system; and
Step 1712: determining, by a charging sequence determination component, a charging sequence and communicating a signal to a charger unit to optimally ramp-up charging to the battery pack.

In an embodiment, the receiving component receives a second message comprising an update to at least one of the charging time and the state-of-health information from the vehicle computer system when the connection is established between the charging station and the vehicle computer system.

In an embodiment, the communication link establishment component is further configured to establish the connection between the charging station and an external device. The charging station then receives a second message comprising an update to at least one of the charging time and the state-of-health information from the external device directly via the connection established.

In another embodiment, the communication link establishment component is further configured to establish the connection between the charging station, the vehicle computer system, and an external device. The charging station receives a second message comprising an update to at least one of the charging time and the state-of-health information from the external device indirectly via the vehicle computer system.

The disclosure herein provides illustration and description but is not intended to be exhaustive or to limit the implementations to the precise form disclosed. Modifications and variations are possible in light of the disclosure herein or may be acquired from practice of the implementations.

Although the present embodiments have been described with reference to specific example embodiments, it will be evident that various modifications and changes may be made to these embodiments without departing from the broader spirit and scope of the various embodiments. For example, the various devices, units, and modules described herein may be enabled and operated using hardware circuitry (e.g., Complementary Metal Oxide Semiconductor (CMOS) based logic circuitry), firmware, software or any combination of hardware, firmware, and software (e.g., embodied in a non-transitory machine-readable medium). For example, the various electrical structures and methods may be embodied using transistors, logic gates, and electrical circuits (e.g., Application Specific Integrated Circuit (ASIC) and/or Digital Signal Processor (DSP) circuit).

In addition, it will be appreciated that the various operations, processes, and methods disclosed herein may be embodied in a non-transitory machine-readable medium and/or a system. Accordingly, the specification and drawings are to be regarded in an illustrative rather than a restrictive sense.

The embodiments described herein can be directed to one or more of a system, a method, an apparatus, and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device, and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA), and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function(s). In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described herein in the general context of computer-executable instructions of a computer program product that runs on a computer and/or computers, those skilled in the art will recognize that the one or more embodiments herein also can be implemented in combination with one or more other program modules. Generally, program modules include routines, programs, components, data structures, and/or the like that perform particular tasks and/or implement particular abstract data types. Moreover, the afore-described computer-implemented methods can be practiced with other computer system configurations, including single-processor and/or multiprocessor computer systems, mini-computing devices, mainframe computers, as well as computers, hand-held computing devices (e.g., PDA, phone), microprocessor-based or programmable consumer and/or industrial electronics and/or the like. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform,” “interface,” and/or the like, can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, and/or nonvolatile random access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synch link DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described herein includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the one or more embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

1-52. (canceled)

53. A system comprising:
a charging station configured to charge an electric vehicle, wherein the charging station comprises
a control unit configured to
establish a connection between the charging station and a vehicle computer system;
receive a message comprising a charging time from the vehicle computer system;
extract a state-of-health information of a battery pack through the vehicle computer system via the connection established; and
communicate a signal to a charger unit to determine a charging sequence to optimally ramp-up charging to the battery pack,
wherein the charging sequence comprises a combination of at least one of a level 1 charging, a level 2 charging, and a level 3 charging.

54. The system of claim 53, wherein the charging station further comprises
the charger unit;
a charger point;
a power distribution network; and
an artificial intelligence unit.

55. The system of claim 54, wherein the charger unit is configured to
receive energy from an energy source;
receive the signal from the control unit; and
convert the energy based on charging requirements of the electric vehicle in accordance with the signal received from the control unit.

56. The system of claim 53, wherein the message comprises 8 bits.

57. The system of claim 53, wherein the message comprises at least one of a vehicle identification (ID), battery mapping information, location of the electric vehicle, distance between the charging station and the electric vehicle, location of an external device of a user, and distance between the charging station and the external device.

58. The system of claim 57, wherein the battery mapping information indicates a first portion, a second portion, and a third portion of the battery pack.

59. The system of claim 57, wherein the battery mapping information comprises information regarding number of batteries in the battery pack.

60. The system of claim 53, wherein the battery pack comprises an individual battery comprising a plurality of cells.

61. The system of claim 60, wherein a first portion of the battery pack comprises a first plurality of cells among the plurality of cells of the battery pack.

62. The system of claim 53, wherein the battery pack comprises at least one of a first battery, a second battery, and a third battery.

63. The system of claim 62, wherein a first portion of the battery pack comprises a plurality of cells from a combination of at least one of the first battery, the second battery, and the third battery.

64. A system comprising:
a charging station configured to charge an electric vehicle, wherein the charging station comprises
a control unit configured to;
establish a connection between the charging station and an external device;
receive an update to at least one of a charging time and a state-of-health information via the external device; and
communicate a signal to a charger unit to modify a charging sequence to optimally ramp-up charging to a battery pack,
wherein the charging sequence comprises a combination of at least one of a level 1 charging, a level 2 charging, and a level 3 charging.

65. The system of claim 64, wherein the external device is configured to
receive the update to the state-of-health information from a vehicle computer system; and
communicate the update to the state-of-health information to the charging station.

66. The system of claim 64, wherein the external device is configured to establish the connection with a vehicle computer system.

67. The system of claim 64, wherein the connection is configured to establish a two-way communication between the charging station and the external device.

68. A method comprising:
establishing, by a charging station, a connection between the charging station and a vehicle computer system;
receiving, by the charging station, a message comprising a charging time from the vehicle computer system;
extracting, by the charging station, a state-of-health information of a battery pack through the vehicle computer system via the connection established; and
communicating, by the charging station, a signal to a charger unit to determine a charging sequence to optimally ramp-up charging to the battery pack,
wherein the charging sequence comprises a combination of at least one of a level 1 charging, a level 2 charging, and a level 3 charging.

69. The method of claim 68, further comprising:
establishing a two-way communication between the charging station and the vehicle computer system.

70. The method of claim 68, wherein the charging time comprises a combination of at least one of a first charging time segment, a second charging time segment, and a third charging time segment.

71. The method of claim 68, wherein the charging sequence comprises a combination of at least one of the level 1 charging that corresponds to a first charging time segment, the level 2 charging that corresponds to a second charging time segment, and the level 3 charging that corresponds to a third charging time segment.

72. The method of claim 68, wherein the charging sequence comprises a combination of at least one of the level 1 charging that corresponds to a first portion, the level 2 charging that corresponds to a second portion, and the level 3 charging that corresponds to a third portion.
